(19) United States
(12) Patent Application Publication
(10) Pub. No.: US 2025/0227100 A1
(43) Pub. Date: Jul. 10, 2025

(54) IMAGING DEVICES, HOST DEVICES, AND METHOD

(71) Applicant: Sony Semiconductor Solutions Corporation, Kanagawa (JP)

(72) Inventors: Akihiko Nagao, Kanagawa (JP); Kumiko Mahara, Kanagawa (JP)

(21) Appl. No.: 18/852,829

(22) PCT Filed: May 1, 2023
(86) PCT No.: PCT/JP2023/017005

§ 371 Date: Sep. 30, 2024

(30) Foreign Application Priority Data
May 18, 2022 (JP) 2022-081282
Mar. 14, 2023 (JP) 2023-039619

(51) Int. Cl. H04L 9/40; H04N 23/661

(52) U.S. Cl. CPC H04L 63/08; H04N 23/662

(57) ABSTRACT

Imaging devices, host devices, and a method are disclosed. In one example, an image sensor includes a first register, a second register, a communication interface, and a controller. The first register storing a first key. The second register storing a counter value. The communication interface configured to communicate with a host device. The controller configured to control the communication interface to receive a request from the host device, change the counter value to generate an updated counter value, and generate a message authentication code based on the first key and the updated counter value in response to receiving the request from the host device.

### TECHNICAL FIELD

The present technology relates to an imaging device, a host device, and a method, and for example, relates to an image sensor, a host device, and a method capable of improving security of communication between an image sensor and a host.

### CROSS REFERENCE TO RELATED APPLICATIONS

This application claims the benefit of Japanese Priority Patent Application JP 2022-081282 filed on May 18, 2022 and the benefit of Japanese Priority Patent Application JP 2023-039619 filed on Mar. 14, 2023, the entire contents of which are incorporated herein by reference.

### BACKGROUND ART

There is a technology for improving security regarding transmission of image data from a camera connected to a network (see, for example, PTLs 1 and 2). On the other hand, some cameras include a register that stores various types of setting information regarding an imaging condition and the like for an image sensor, various types of setting information regarding transmission of image data from the image sensor to a host inside the camera, and the like.

### CITATION LIST

### Patent Literature

PTL 1: JP 2019-33368 A
PTL 2: JP 2018-525866 A

### SUMMARY OF INVENTION

### Technical Problem

It is desired to improve security of communication between an image sensor and a host.

The present technology has been made in view of such a situation, and an object of the present technology is to improve security of communication between an image sensor and a host.

### Solution to Problem

A data processing apparatus according to one aspect of the present technology is a data processing apparatus including: a generation unit that generates, in a case of transmitting data to another data processing apparatus, a message authentication code for which a counter value obtained by counting a request for the transmission and the data are set as computation targets; and a transmission unit that transmits the message authentication code generated by the generation unit after the transmission of the data. An imaging device according to one aspect of the present technology is an image sensor including: a first register storing a first key, a second register storing a counter value, a communication interface configured to communicate with a host device, and a controller configured to control the communication interface to receive a request from the host device, change the counter value to generate an updated counter value, and generate a message authentication code based on the first key and the updated counter value in response to receiving the request from the host device.

A data processing method according to one aspect of the present technology is a data processing method including: by a data processing apparatus, generating, in a case of transmitting data to another data processing apparatus, a message authentication code for which a counter value obtained by counting a request for the transmission and the data are set as computation targets; and transmitting the generated message authentication code after the transmission of the data. A host device according to one aspect of the present technology is a host device including: a first register storing a first key, a second register storing a counter value, a communication interface configured to communicate with an image sensor, and a controller configured to control the communication interface to transmit a request to the image sensor, change the counter value to generate an updated counter value, and generate a message authentication code based on the first key and the updated counter value in response to transmitting the request to the image sensor.

A program according to one aspect of the present technology is a program for causing a computer that controls a data processing apparatus to execute processing of: generating, in a case of transmitting data to another data processing apparatus, a message authentication code for which a counter value obtained by counting a request for the transmission and the data are set as computation targets; and transmitting the generated message authentication code after the transmission of the data. A method according to one aspect of the present technology is a method including: controlling, with a controller of an image sensor, a communication interface to receive a request from a host device, changing, with the controller, a counter value to generate an updated counter value, and generating, with the controller, a message authentication code based on a first key and the updated counter value in response to receiving the request from the host device.

In the data processing apparatus, the data processing method, and the program according to one aspect of the present technology, in a case of transmitting data to another data processing apparatus, a message authentication code for which a counter value obtained by counting a request for the transmission and the data are set as computation targets is generated, and the generated message authentication code is transmitted after the data is transmitted.

Note that the data processing apparatus may be an independent apparatus or an internal block included in one apparatus.

Note that the program can be provided by being transmitted via a transmission medium or by being recorded on a recording medium.

### BRIEF DESCRIPTION OF DRAWINGS

FIG. 1 is a diagram illustrating an example of a configuration of a data transmission system according to an embodiment of the present disclosure.

FIG. 2 is a diagram illustrating an example of a configuration of a complementary metal-oxide semiconductor (CMOS) image sensor (CIS).

FIG. 3 is a diagram illustrating an example of a configuration of a write determination unit.

FIG. 4 is a diagram for explaining a concept of MAC addition.

FIG. 5 is a diagram illustrating an example of a register map.

FIG. 6 is a diagram for explaining data transmitted at the time of writing data.

FIG. 7 is a diagram for explaining increment of a counter.

FIG. 8 is a diagram for explaining processing at the time of writing data.

FIG. 9 is a diagram for explaining another processing at the time of writing data.

FIG. 10 is a diagram for explaining data transmitted at the time of reading data.

FIG. 11 is a diagram for explaining increment of the counter.

FIG. 12 is a diagram for explaining processing at the time of reading data.

FIG. 13 is a diagram for explaining another processing at the time of reading data.

FIG. 14 is a diagram for explaining exchange between the CIS and a host.

FIG. 15 is a diagram for explaining another exchange between the CIS and the host.

FIG. 16 is a diagram for explaining another system configuration example.

FIG. 17 is a diagram for explaining another exchange between the CIS and the host.

FIG. 18 is a diagram for explaining another exchange between the CIS and the host.

FIG. 19 is a diagram for explaining another system configuration example.

FIG. 20 is a diagram for explaining another exchange between the CIS and the host.

FIG. 21 is a diagram for explaining an example of a configuration of a personal computer (C).

FIG. 22 is a block diagram illustrating an example of a schematic configuration of a vehicle control system.

FIG. 23 is an explanatory diagram illustrating an example of installation positions of an outside-vehicle information detecting unit and an imaging section.

### DESCRIPTION OF EMBODIMENTS

Hereinafter, modes (hereinafter, referred to as embodiments) for implementing the present technology will be described.

### Overall Configuration Example of Data Transmission System

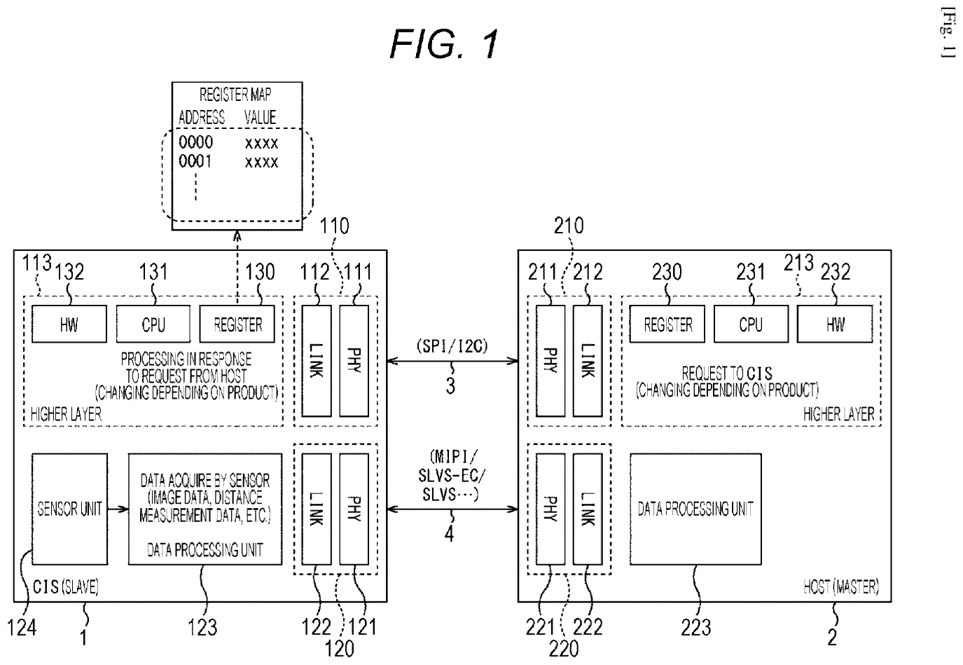

FIG. 1 schematically illustrates an example of an overall configuration of a data transmission system according to an embodiment of the present disclosure.

The data transmission system according to an embodiment relates to, for example, a technology for improving security of register communication between an image sensor (complementary metal-oxide semiconductor (CMOS) image sensor (CIS) 1) inside a camera and a host 2.

The data transmission system illustrated in FIG. 1 includes the CIS 1 as a data processing apparatus, the host 2, a transmission path 3, and a transmission path 4.

The CIS 1 includes a communication unit 110, a higher layer 113, a communication unit 120, a data processing unit 123, and a sensor unit 124.

The communication unit 110 includes a physical layer (PHY) 111 and a link layer (LINK) 112. The communication unit 120 includes a physical layer (PHY) 121 and a link layer (LINK) 122.

The higher layer 113 includes a register 130, a central processing unit (CPU) 131, and hardware (HW) 132. Note that the higher layer 113 may also have a configuration in which the CPU 131 is omitted.

The host 2 includes a communication unit 210, a higher layer 213, a communication unit 220, and a data processing unit 223.

The communication unit 210 includes a physical layer (PHY) 211 and a link layer (LINK) 212. The communication unit 220 includes a physical layer (PHY) 221 and a link layer (LINK) 222. The data processing unit 223 can perform authentication processing on image data transmitted from the CIS 1.

The higher layer 213 includes a register 230, a CPU 231, and hardware (HW) 232. The register 230 functions as a holding unit that holds a write counter value and a read counter value to be described later, and can be implemented by a memory.

The CIS 1 includes a communication interface (IF) (register IF) that performs communication in which the CIS 1 is a slave and the host 2 is a master, and a high-speed IF (data output IF) that outputs large data such as image data acquired by the sensor unit 124.

Each of the communication unit 110 of the CIS 1 and the communication unit 210 of the host 2 configures the communication IF (register IF) capable of mutual communication (register communication) between the registers 130 and 230 via the transmission path 3. The register IF may be configured to be capable of switching a plurality of types of IFs by mounting a plurality of types of IFs with different protocols. For example, two types of IFs of a serial peripheral interface (SPI) and an inter integrated circuit (I2C) may be mounted and be switchable.

The communication unit 120 of the CIS 1 configures the high-speed IF (data output IF) that outputs large data such as image data acquired from the sensor unit 124 for the communication unit 220 of the host 2 via the transmission path 4. Examples of the high-speed IF include a mobile industry processor interface (MIPI), scalable low voltage signaling with embedded clock (SLVS-EC), and scalable low voltage signaling (SLVS).

The register 130 of the CIS 1 stores setting information transmitted from the host 2 via the register IF. The register 130 functions as a holding unit that holds a write counter value and a read counter value to be described later, and can be implemented by a memory. A processing operation of each unit inside the CIS 1 is determined depending on what value is set as the setting information in the register 130. Examples of the setting information include information such as an exposure time, a gain, a resolution (pixel addition and thinning number), a frame rate, a region of interest (ROI), and other operation modes.

The register 130 of the CIS 1 also stores information of various states in the CIS 1, environmental information, and the like. The information of various states, the environmental information, and the like stored in the register 130 can be read from the host 2 via the register IF. Examples of the information of various states, the environmental information, and the like include temperature information inside the CIS 1, metadata in a case where image information from the sensor unit 124 is processed by the data processing unit 123, and error or warning detection information.

In the host 2, the higher layer 213 determines how to cause the CIS 1 to behave, and a value that determines the behavior of the CIS 1 is transmitted as the setting information via the register IF. The host 2 changes the value of the setting information according to the information of various states, the environment information, and the like read from the register 130 of the CIS 1. Since the behavior of the CIS 1 varies depending on a use case, software (SW) of the CPU 231 of the host 2 is often configured to be rewritable in a relatively easy manner. In a case where the higher layer 213 is implemented by a field programmable gate array (FPGA), both the CPU 231 and the hardware 232 have a variable configuration.

As standards of the physical layers 111 and 211 and the link layers 112 and 212 included in the register IF are defined as rules and determined, communication between the CIS 1 and the host 2 can be performed regardless of products. A product-specific portion is only required to be determined only by the higher layers 113 and 213, for example, according to a specification (definition of an address and a value) of the registers 130 and 230 or the like.

For example, how to transmit the setting information in the register IF is defined as a rule as the specifications of the physical layers 111 and 211 and the link layers 112 and 212. As a result, the higher layers 113 and 213 can exchange control information and other information between the CIS 1 and the host 2 via the register IF only by defining the addresses of the registers 130 and 230, an operation in a case where a value is set in the register 130, and the like.

### <Circuit Configuration>

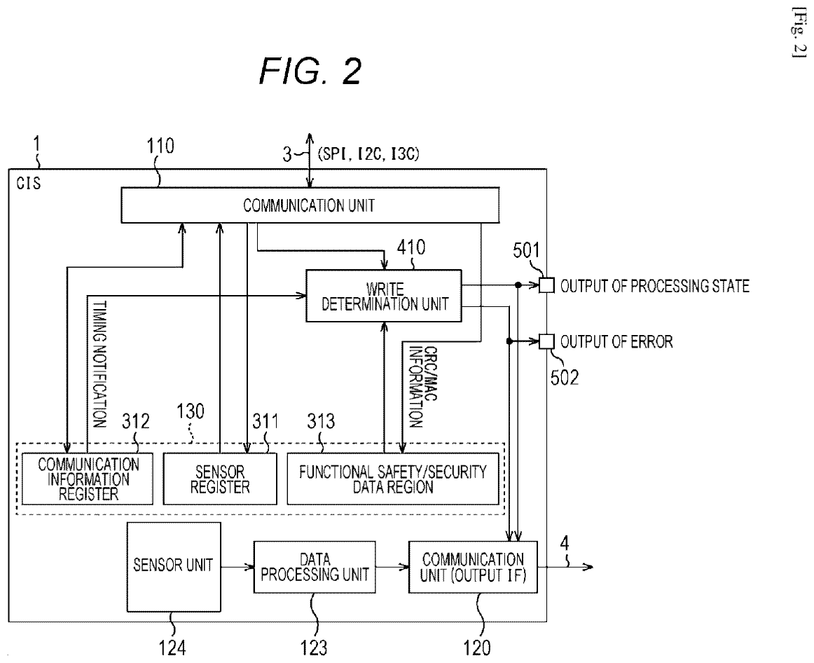

FIG. 2 schematically illustrates an example of a configuration of the CIS 1 as the data processing apparatus. In the configuration example illustrated in FIG. 2, the CIS 1 includes the communication unit 110, the communication unit 120, the data processing unit 123, the sensor unit 124, the register 130, a write determination unit 410, a processing state output terminal 501, and an error output terminal 502.

The processing state output terminal 501 outputs, as notification information, a processing status (processing state FS_S_ACT) indicating a processing state in the register 130 to the host 2. The error output terminal 502 outputs, as notification information, error information (error state FS_S_ERR) generated in processing in the register 130 to the host 2.

The data processing unit 123 performs various types of data processing on the sensor data output from the sensor unit 124. The communication unit 120 adds the notification information such as the error information to the sensor data subjected to various types of data processing in the data processing unit 123, and outputs the sensor data to the host 2.

FIG. 2 illustrates a configuration example in a case where, after a setting value is written in the sensor register 311, whether or not the written value is a correct value is determined by, for example, a message authentication code (MAC).

In the following description, a case where, after writing of the setting value (setting information) to the sensor register 311 is reflected, the determination of whether the setting information to be reflected to the sensor register 311 is correct or incorrect is performed on the basis of security data will be described as an example. It is also possible to adopt a configuration in which, before writing of the setting information to the sensor register 311 is reflected, whether the setting information to be reflected to the sensor register 311 is correct or incorrect is determined on the basis of the security data (MAC data or the like), and the setting information is reflected to the sensor register 311 only in a case where the setting information is determined to be correct. In other words, the write determination unit 410 can also be configured to perform authentication processing on the setting information transmitted from the host 2 to reflect the setting information in the sensor register 311 only in a case where it is determined by the authentication processing that the setting information is correct.

The setting values from the host 2 are sequentially reflected in the sensor register 311 via the communication unit 110. Note that the reflection of the setting value in each unit of the CIS 1 may be made, for example, after latching at a timing of a frame synchronization signal (Frame Sync) of the sensor data.

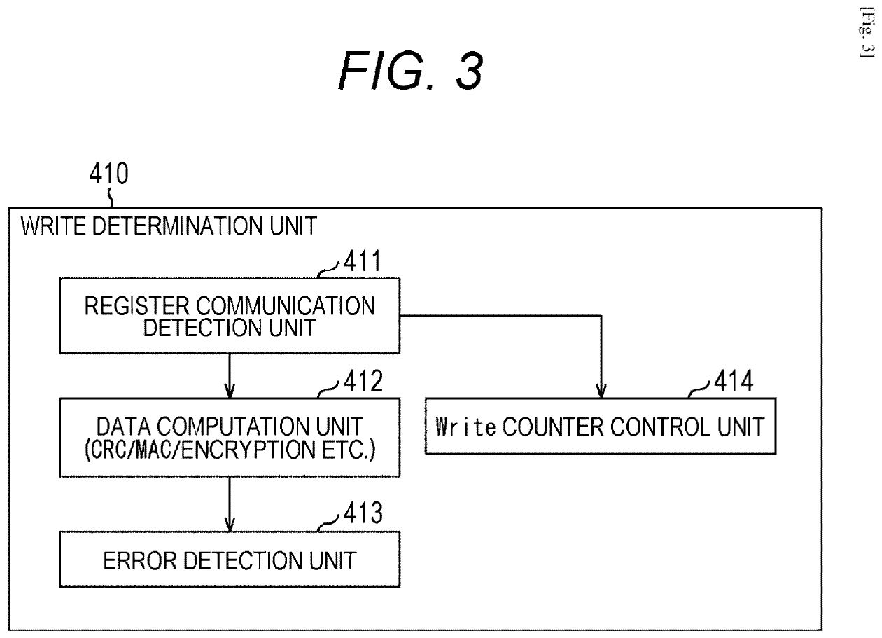

FIG. 3 illustrates a specific example of the write determination unit 410 in the CIS 1 illustrated in FIG. 2.

The write determination unit 410 includes a register communication detection unit 411, a data computation unit 412, an error detection unit 413, and a write counter control unit 414.

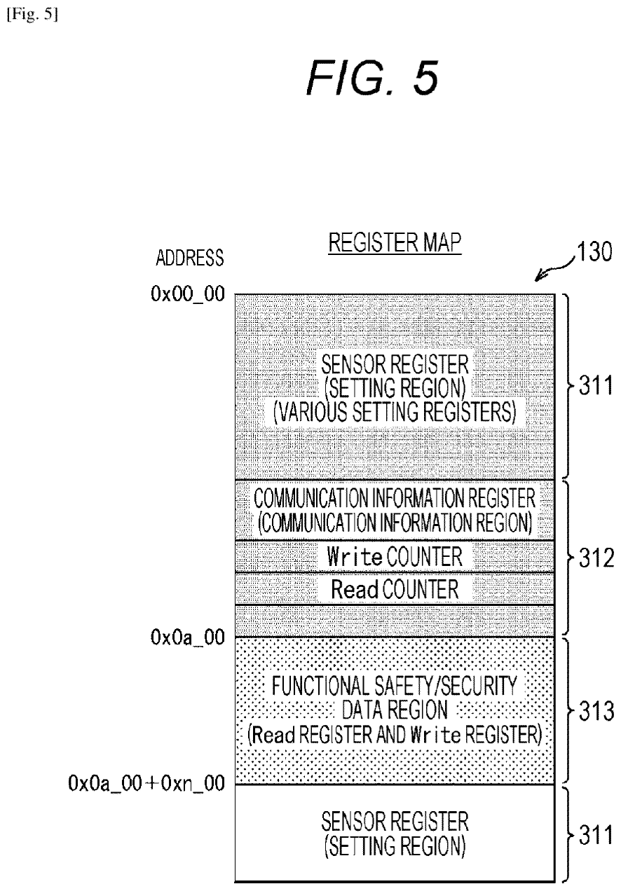

The register communication detection unit 411 detects that register communication has been performed. The data computation unit 412 performs computation related to cyclic redundancy check (CRC), the MAC, encryption, and the like. The error detection unit 413 performs error detection based on the computation result of the data computation unit 412. The write counter control unit 414 counts requests for writing to the register 130 on the basis of the detection result of the register communication detection unit 411, and updates a counter value of a write counter (FIG. 5) of the register 130.

After the writing of the setting information is reflected in the sensor register 311, the write determination unit 410 determines whether the setting information reflected in the sensor register 311 is correct or incorrect on the basis of the security data. As described above, it is also possible to perform determination of whether the setting information reflected in the sensor register 311 is correct or incorrect on the basis of the security data, and reflect the setting information in the sensor register 311 after the setting information is determined to be correct.

The communication information register 312 notifies the write determination unit 410 of a computation start timing and a computation completion timing in the data computation unit 412. In addition, notification of completion of writing of the security data such as CRC data and the MAC data to the functional safety/security data region 313 (determination timing) or the like is made from the communication information register 312.

### <General Safety/Security Technology>

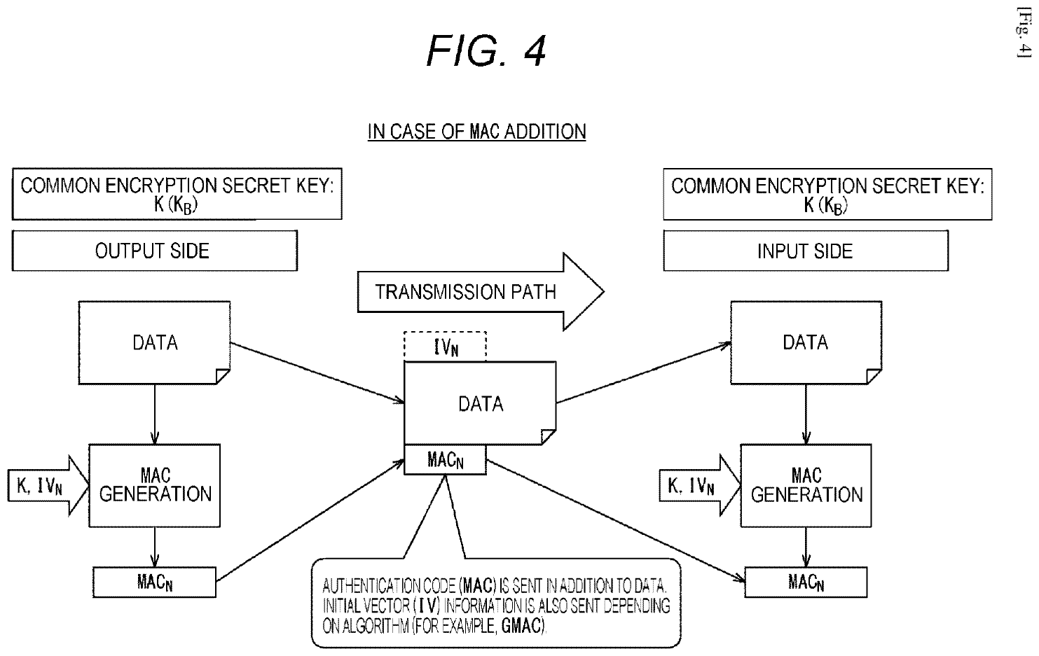

FIG. 4 schematically illustrates an example of communication by message authentication code (MAC) addition as a general safety/security technology.

There is a technology of adding the MAC or a signature to a function of detecting data transmission due to data falsification or spoofing. In general, the MAC is often used for communication requiring a real-time property like the communication IF or the like (a signature may also be used).

In a case of the technology of adding the MAC, a common encryption secret key K (KB) is provided on a data output side and a data input side. On the data output side, the MAC is generated using the common encryption secret key K (KB), and the generated MAC is added to communication target data and output. Depending on a MAC algorithm, initial vector (IV) information is also added and output.

For example, in a case of a cipher-based message authentication code (CMAC), the IV information is not necessary because calculation is performed with IVO, but in a case of using a Galois message authentication code (GMAC), the IV information is also added and output. On the data input side, the MAC is generated using the common encryption secret key K (KB), and is compared with the MAC added to the data to perform data authentication. In certain embodiments, the MAC may be at least one part of an overall authentication.

### <Configuration of Register>

FIG. 5 illustrates an example of a configuration (register map) of the register 130. Note that an address in the register map illustrated in FIG. 5 is an example, and can be changed as necessary.

The register 130 in the CIS 1 has a setting region (sensor register 311) for storing the setting information transmitted from the host 2 as an address region. In addition to the sensor register 311, a communication information region (communication information register 312) for storing communication information with the host 2, and a security data region (functional safety/security data region 313) for storing the security data for the setting information as a safety/security address region are further provided.

The communication information register 312 is a mode setting register for safety/security. The communication information register 312 stores, as the communication information, for example, communication mode information indicating a communication mode of register communication, status information indicating start of register communication, and status information indicating end of register communication. The communication information is indicated by FS_S_STATE as described later, for example. For example, FS_S_STATE=0 indicates the end of communication, and FS_S_STATE≠0 indicates the start of communication.

Between the CIS 1 and the host 2, safety/security information is exchanged in the higher layers 113 and 213 by using the safety/security address region in the register 130. A function corresponding to a target connectable by the existing register IF can be selected or changed later, so that safety/security confirmation can be performed in the higher layers 113 and 213 instead of determining by a protocol rule of the register IF. A function of determining whether or not it is the safety/security address region or a function of enabling selection of whether or not to access the safety/security address region may be provided.

The communication information register 312 also stores a write counter that counts the number of requests for writing and a read counter that counts the number of requests for reading. A region in which the write counter and the read counter are stored is set as a read region in which the stored counter value is read in a case where there is a request for reading from the host 2, and is set as a region in which writing is not permitted even in a case where there is a request for writing from the host 2.

Here, an example in which the write counter and the read counter are separately provided, and the number of requests for writing and the number of requests for reading are separately counted will be described. The write counter and the read counter may be implemented by one counter, and a counter that counts the number of requests for writing and the number of requests for reading may be used. In other words, it is also possible to provide a counter that counts the number of times that the request is received to implement the following embodiments.

As described later, the functional safety/security data region 313 stores, for example, the message authentication code (MAC) related to the setting information as the security data. The functional safety/security data region 313 is, for example, an address region of 256 bytes×n. The functional safety/security data region 313 may include a write register for writing the security data and a read register for reading.

### Example of Writing of Setting Information in MAC Mode

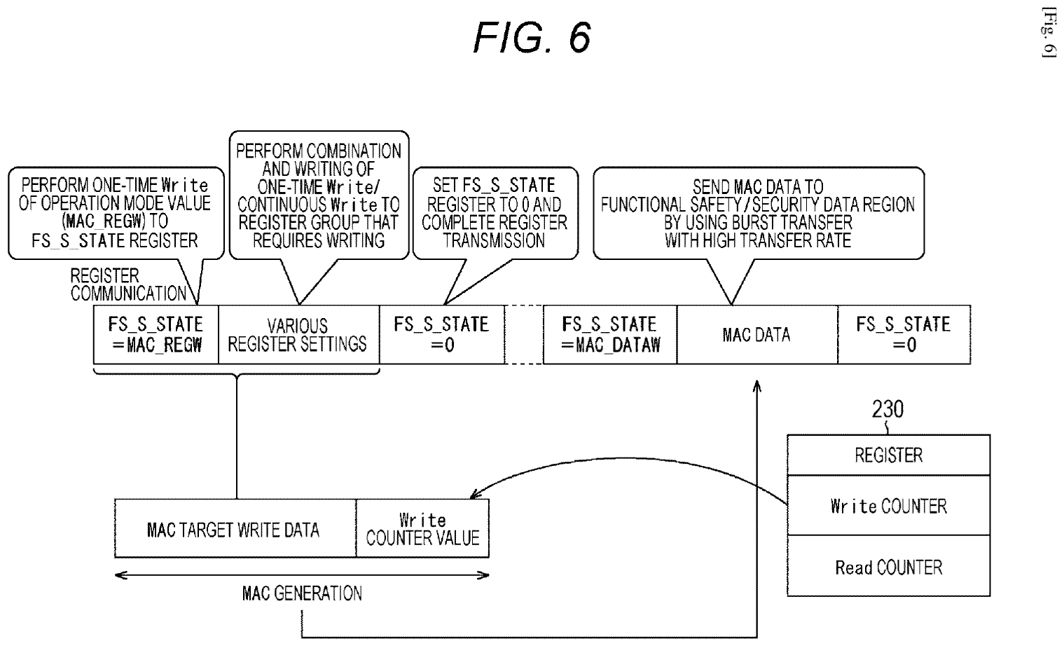

Hereinafter, a communication mode using the MAC is referred to as a MAC mode. FIG. 6 is a sequence diagram illustrating an example of the register communication. FIG. 6 illustrates an example of register communication in a case where the setting information is written to the sensor register 311 in the MAC mode.

First, a status FS_S_STATE=MAC_REGW indicating a request to start writing the setting information to the sensor register 311 in the MAC mode is transmitted as the communication information from the host 2 via the register IF. The CIS 1 performs one-time write of an operation mode value (MAC_REGW) to an FS_S_STATE register of the communication information register 312.

Next, information desired to be written to the sensor register 311, for example, the setting information (information regarding various register settings), is transmitted from the host 2 via the register IF. As the setting information, for example, an address for which the setting value in the sensor register 311 is desired to be changed and a setting value group (a plurality of combinations is possible) are transmitted.

In the CIS 1, the setting information is written to the sensor register 311. As a result, various register settings are made in the sensor register 311. In the sensor register 311, one-time write (write) and continuous write (write) may be combined and written to a register group that requires writing.

Next, a status FS_S_STATE=0 indicating a request to end writing the setting information to the sensor register 311 in the MAC mode is transmitted as the communication information from the host 2 via the register IF. In the CIS 1, the operation mode value of the FS_S_STATE register of the communication information register 312 is set to 0.

Next, a status FS_S_STATE=MAC_DATAW indicating a request to start writing the security data in the MAC mode is transmitted as the communication information from the host 2 via the register IF. The CIS 1 performs one-time write of an operation mode value (MAC_DATAW) to the FS_S_STATE register of the communication information register 312.

Next, the security data (MAC data) in the MAC mode is transmitted from the host 2 via the register IF. Processing relating to the generation of the MAC data will be described later with reference to the lower side of FIG. 6.

In the CIS 1, the MAC data is written to the functional safety/security data region 313. The MAC data may be transmitted by burst transfer with a high transfer rate. As the security data, information necessary for processing other than the MAC may also be transmitted. For example, mode information of the MAC in a case where there is a plurality of algorithms and information such as an IV in a case where the GMAC is used may also be transmitted. In a case where a plurality of algorithms can be supported, the operation mode may be fixed in advance at the time of activation of the product, the fuse, or the like.

Next, a status FS_S_STATE=0 indicating a request to end writing of the security data in the MAC mode is transmitted as the communication information from the host 2 via the register IF. In the CIS 1, the operation mode value of the FS_S_STATE register of the communication information register 312 is set to 0.

The MAC data transmitted in the MAC mode is data generated by setting MAC target write data and a write counter value read from the write counter of the register 230 as MAC computation targets. The MAC target write data includes a status FS_S_STATE=MAC_REGW indicating a request to start writing the setting information to the sensor register 311 in the MAC mode, and the setting information for the sensor register 311 transmitted from the host 2 to the CIS 1 via the register IF. The write counter is the write counter value written to the register 230 of the host 2.

The MAC data is generated by performing computation using the setting information and the write counter value transmitted to the CIS 1 as the MAC computation targets by using the common encryption secret key K (KB) (FIG. 4). Then, as described above, the generated MAC data is transmitted after the transmission of the status FS_S_STATE=MAC_DATAW indicating the request to start writing the security data in the MAC mode.

As described above, by storing the status information indicating the start of communication and the status information indicating the end of communication as the communication information in the communication information register 312, a lump of data can be transmitted from the host 2 regardless of the address region of the register 130 desired to be set, and communication that is not affected by a transfer unit such as burst transfer can be performed.

The start of data transmission can be clarified between the host 2 and the CIS 1. A plurality of addresses and data can be collectively set as MAC targets. As the MAC data is transmitted for each transfer unit or the like, data transmission can be more ef-ficiently performed. By performing computation including the value of the write counter at the time of generating the MAC data, resistance to an attack such as spoofing can be imparted.

### Example of Operation of Write Counter

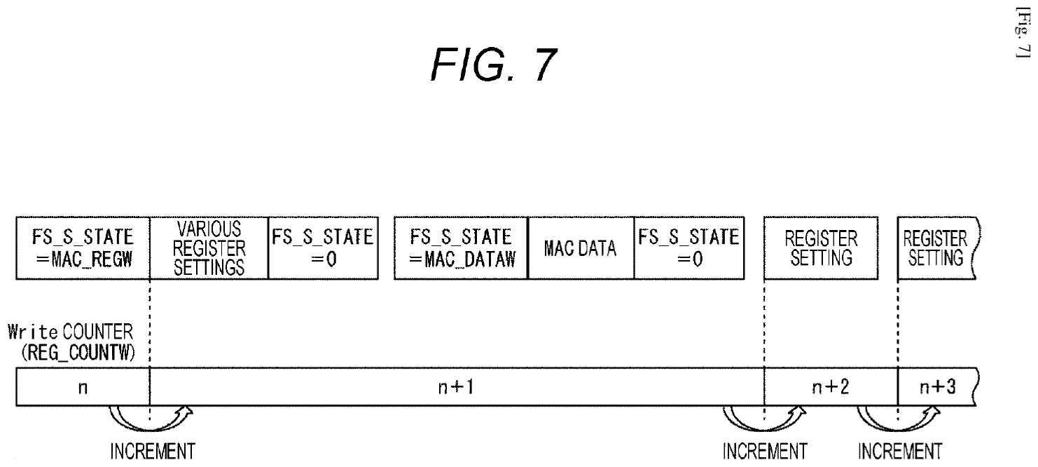

FIG. 7 is a sequence diagram illustrating an example of register communication including an operation of the write counter. FIG. 7 illustrates an example of register communication in a case where the setting information is written to the sensor register 311 in the MAC mode.

In the host 2 side, the counter value of the write counter held in the register 230 is incremented at a time point at which, for example, register communication (FS_S_STATE=MAC_REGW) indicating the request for writing is generated (output). In the example illustrated in FIG. 7, the write counter of the register 230 is updated from n to n+1. In this case, the write counter value used to generate the MAC data is n+1.

Here, a case where the write counter held in the register 230 is incremented at a time point at which the request for writing is generated (output) is described as an example. However, the counter value may be incremented at the time of generating (outputting) register communication (FS_S_STATE=0) indicating the end of writing. In a case of transmitting the MAC data, the counter value is incremented at a time point at which register communication (FS_S_STATE=0) is generated (output) after the transmission of the MAC data.

In this case, the counter value is incremented after the MAC data is generated. The counter value may be updated before the MAC data is generated, or may be updated after the MAC data is generated.

On the CIS 1 side, the write counter held in the register 130 is updated at a time point at which the register communication (FS_S_STATE=MAC_REGW) indicating the request for writing is received (processed). The write counters held in the register 130 of the CIS 1 and the register 230 of the host 2 are synchronized with each other, and basically hold the same counter value. In the example illustrated in FIG. 7, the write counter of the register 130 is updated from n to n+1. In this case, the write counter value used to generate the MAC data is n+1.

In a case where the status FS_S_STATE=MAC_DATAW indicating a request to start writing security data in the MAC mode is received, the CIS 1 writes the MAC data received thereafter to the register 130.

In the CIS 1, a timing at which the write counter value is incremented needs to be matched with a timing at which the write counter value is incremented in the host 2. As described above, in a case where the host 2 side updates the counter value before generating the MAC data, in other words, updates the counter value at the time of making the request for writing, the CIS 1 side updates the counter value at a time point at which the request for writing is received. In this case, the counter value is updated before the generation of the MAC data.

In a case where the host 2 side updates the counter value after generating the MAC data, in other words, updates the counter value at the time of making the notification of the end of writing after transmitting the MAC data, the CIS 1 side updates the counter value at a time point at which the notification of the end of writing is received. In this case, the counter value is updated after the generation of the MAC data.

As described above, the CIS 1 can also be configured in such a way that the counter value is updated before the MAC data is generated, or the counter value is updated after the MAC data is generated. However, the counter value is updated at the same timing as that in the host 2 side.

The CIS 1 sets, as the MAC computation targets, various register setting values (data set as the MAC target write data in the host 2 side) received and written into the register 130 at a time point before receiving the MAC data and the write counter value held in the register 130, and generates the MAC data by using the common encryption secret key K held by the CIS 1.

The generated MAC data is compared with the received MAC data to confirm safety of the data. That is, if the pieces of MAC data are the same, various register setting values written to the register 130 are applied as safe data that has not been altered or the like, and if the pieces of MAC data are not the same, it is determined that the data is not safe data, and the data is not applied and is processed as an error.

In this manner, the MAC data is generated from data including the write counter value, and each write counter is incremented according to communication in such a way that the values are the same between the CIS 1 and the host 2. Therefore, for example, even in a case where there is an attack such as spoofing, the processing can be continued without being affected by the attack. For example, a case where an attacker copies and holds data from the host 2 to the CIS 1, and transmits the data to the CIS 1 at a later timing is considered.

It is assumed that the data copied by the attacker is data including the MAC data generated with the write counter value of n as the MAC computation target. In the CIS 1, the write counter value is sequentially updated to n−1, n, n+1, and the like, and a state in which the MAC data generated from the updated write counter is received and processing is performed without detecting an error is continued.

In such a state, in a case where the attacker transmits, to the CIS 1, the data including the MAC data generated in a case where the write counter value is n, the MAC data generated with the write counter different from the write counter managed by the CIS 1 is received. Therefore, the CIS 1 can detect that the MAC data transmitted by the attacker and the MAC data generated from the write counter value managed by the CIS 1 do not match and the MAC data by the attacker is not valid data transmitted from the host 2.

As described above, even in a case where an attack is received from an attacker, the influence of the attack can be reduced. In order to avoid such an attack, it is also conceivable to transmit the write counter value itself from the host 2 to the CIS 1. For example, it is also conceivable to transmit the write counter value after transmitting write target data, and further transmit the MAC data generated only from the write target data (data not including the write counter). By transmitting the write counter value every time the write target data is transmitted in this manner, the CIS 1 side can compare the transmitted write counter value with the write counter value managed by itself and detect that it is an attack from an attacker if they do not match.

In this case, since the write counter value needs to be transmitted every time the write target data is transmitted, a time required for transmitting the write counter value is necessary, and there is a possibility that a communication band is affected. As described with reference to FIGS. 6 and 7, by generating the MAC data on the basis of the write counter value and transmitting the MAC data, it is not necessary to transmit and receive the write counter value itself, and it is possible to prevent the communication band from being affected.

As described above, according to the present technology, security can be improved without affecting the communication band.

### <Processing in Data Transmission System at the Time of Writing>

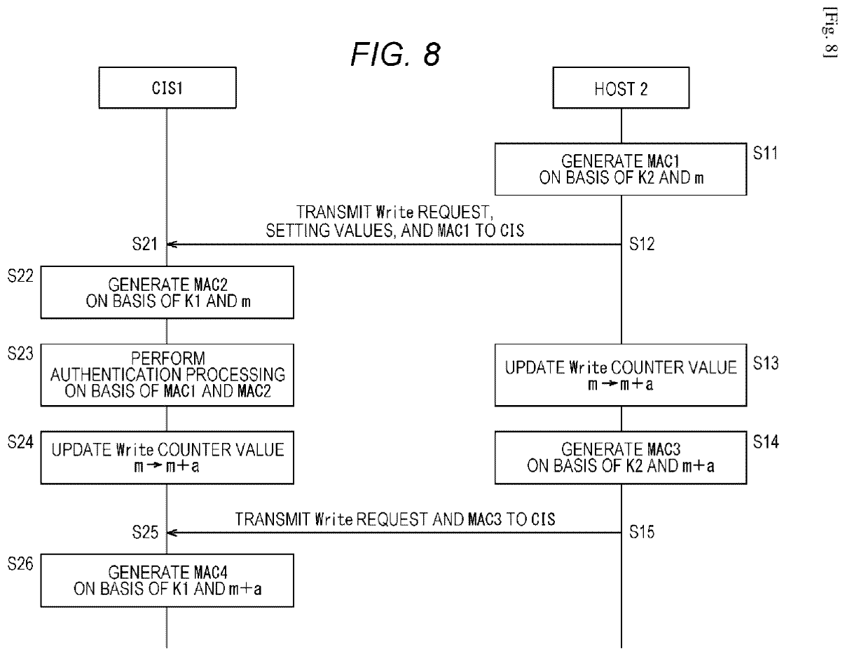

The processing in the data transmission system (FIG. 1) at the time of writing will be further described with reference to the timing chart of FIG. 8.

In step S11, the host 2 generates a write request, setting values of various registers, a MAC 1, and the like to be transmitted to the CIS 1 in step S12. In a case where a value of the write counter managed by the host 2 is m, the MAC 1 is generated by performing computation using the setting information and the write counter value (in this case, m) transmitted to the CIS 1 as the MAC computation targets by using a common encryption secret key K2.

Here, a case where the MAC computation is performed by a common key encryption method using the common encryption secret key K will be described as an example, but the MAC computation may also be performed by a public key encryption method. In a case where the MAC computation is performed using the public key encryption method, the host 2 may manage the secret key and the CIS 1 may manage the public key, or the host 2 may manage the public key and the CIS 1 may manage the secret key.

In a case where a key managed by the CIS 1 is set as a first key, a key managed by the host 2 is set as a second key, and the MAC computation is performed by the common key encryption method, the first key and the second key are common keys. In a case where the MAC computation is performed by the public key encryption method, the first key is a secret key, and the second key is a public key, or the first key is a public key, and the second key is a secret key.

The common key encryption method or the public key encryption method can be applied as the encryption method. In addition, a method using both the common key encryption method and the public key encryption method (a method called hybrid encryption method) can also be applied.

In step S12, the write request, the setting values of various registers, the MAC 1, and the like are transmitted from the host 2 to the CIS 1 in the order described with reference to FIG. 6.

In step S21, upon receiving the write request or the like from the host 2, the CIS 1 generates a MAC 2 in step S22. The CIS 1 sets, as the MAC computation targets, various register setting values (data set as the MAC target write data in the host 2 side) received and written into the register 130 and the write counter value (in this case, m) held in the register 130, and generates the MAC 2 by using a common encryption secret key K1 held by the CIS 1.

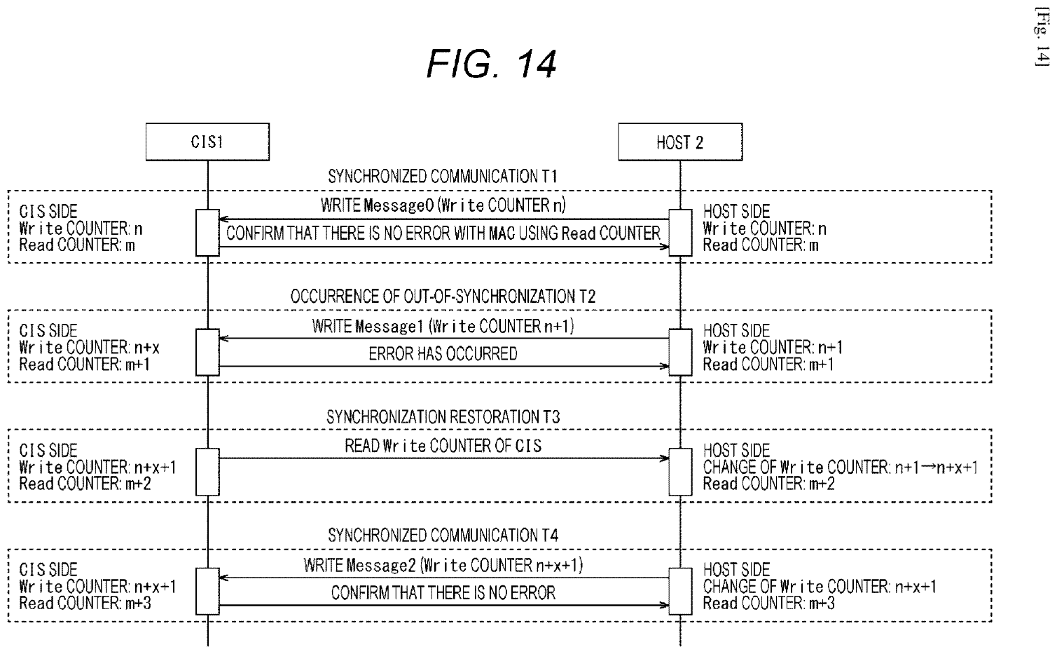

In step S23, the CIS 1 performs data authentication processing by comparing the received MAC 1 with the generated MAC 2. As a result of the authentication processing in step S23, in a case where it is determined that the MAC 1 and the MAC 2 do not match, it is determined that an error has occurred, and processing in a case where the error has occurred is performed. The processing in a case where an error has occurred will be described later with reference to FIG. 14, and processing for notifying the host 2 that an error has occurred and synchronizing the write counter value is performed.

In step S24, the CIS 1 updates the write counter value of the write counter held in the register 130. In a case where the write counter value held in the register 130 is m, the write counter value is updated to m+a. In step S13, in the host 2 side, the held write counter value managed by the register 230 is updated. In a case where the write counter value held in the register 230 is m, the write counter value is updated to m+a.

The write counter value and the read counter value to be described later are updated by adding or subtracting a predetermined value a. In a case where the predetermined value a is set to “+1”, the counter value is updated by adding 1. In a case where the predetermined value a is set to “−1”, the counter value is updated by subtracting 1. The predetermined value a may be a value other than 1 or does not have to be an integer.

The processing in steps S24 and S13 is performed in each of the CIS 1 and the host 2, whereby the counter value of the write counter is updated.

In a case where there is further data to be written in the CIS 1, the host 2 generates a MAC 3 by performing computation using the updated write counter value, the data to be written, and the write request as the MAC computation targets, by using the common encryption secret key K2, in step S14. In step S15, the write request, the data to be written, and the generated MAC 3 are transmitted from the host 2 to the CIS 1.

In step S25, upon receiving the MAC 3 and the like transmitted from the host 2, the CIS 1 generates a MAC 4 in step S26. The MAC 4 is generated using the counter value (in this case, m+a) updated in step S24 and the common encryption secret key K1. The authentication processing is performed by comparing the generated MAC 4 with the received MAC 3.

By performing such processing between the CIS 1 and the host 2, writing from the host 2 to the CIS 1 is performed. In a case where write requests of a plurality of setting values are transmitted from the host 2 to the CIS 1, the processing from step S11 to step S15 and the processing from step S21 to step S26 are repeatedly performed.

### <Another Processing in Data Transmission System at the Time of Writing>

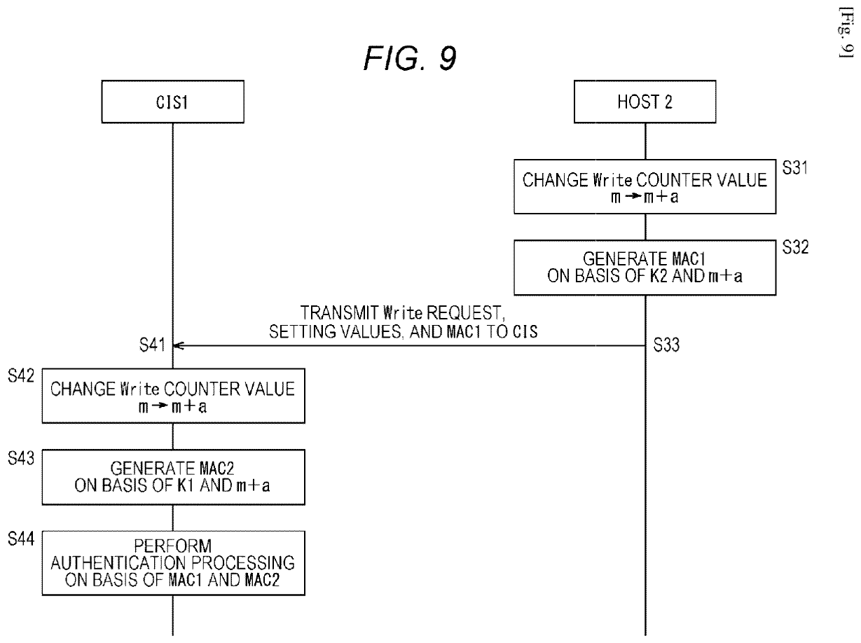

Another processing in the data transmission system (FIG. 1) at the time of writing will be further described with reference to the timing chart of FIG. 9.

In step S31, the host 2 updates the write counter value of the write counter at the timing of transmitting the write request to the CIS 1. In a case where the write counter value held in the register 230 is m, the host 2 updates the write counter value to m+a.

In step S32, the host 2 generates the MAC 1 by using the updated write counter value, in this case, m+a. The MAC 1 is generated by performing computation using the setting information and the write counter value (in this case, m+a) transmitted to the CIS 1 as the MAC computation targets by using the common encryption secret key K2.

Although an example in which the host 2 generates and transmits the write request, and then updates the write counter value has been described in the processing at the time of writing described with reference to FIG. 8, the host 2 updates the write counter value before generating the write request in the processing at the time of writing described with reference to FIG. 9. As described above, in the host 2, the write counter value is updated before transmission of the write request, and the MAC can be generated using the updated counter value.

In step S33, the host 2 transmits the generated MAC 1, the write request, the setting value, and the like to the CIS 1. In step S41, upon receiving the write request or the like from the host 2, the CIS 1 updates the write counter value of the write counter in step S42. In a case where the write counter value of the write counter held in the register 130 is m, the CIS 1 updates the write counter value to m+a.

In step S43, the MAC 2 is generated using the updated write counter value, in this case, m+a. The MAC 2 is generated by performing computation using the setting information and the write counter value received by the CIS 1 (in this case, m+a) as the MAC computation targets by using the common encryption secret key K1. In step S44, the CIS 1 performs authentication processing by comparing the received MAC 1 with the generated MAC 2.

Although an example in which the CIS 1 receives the write request, performs the authentication processing, and then updates the write counter value has been described in the processing at the time of writing described with reference to FIG. 8, the CIS 1 receives the write request and updates the counter value of the write counter before performing the authentication processing in the processing at the time of writing described with reference to FIG. 9. As described above, in the CIS 1, the write counter value is updated based on the write request being received, and the MAC can be generated using the updated write counter value.

In a case where there is data to be written in the CIS 1, the processing described with reference to FIG. 9 is performed in each of the CIS 1 and the host 2, so that the processing of writing data to the CIS 1 including the authentication processing is performed.

### Example of Reading of Setting Information in MAC Mode

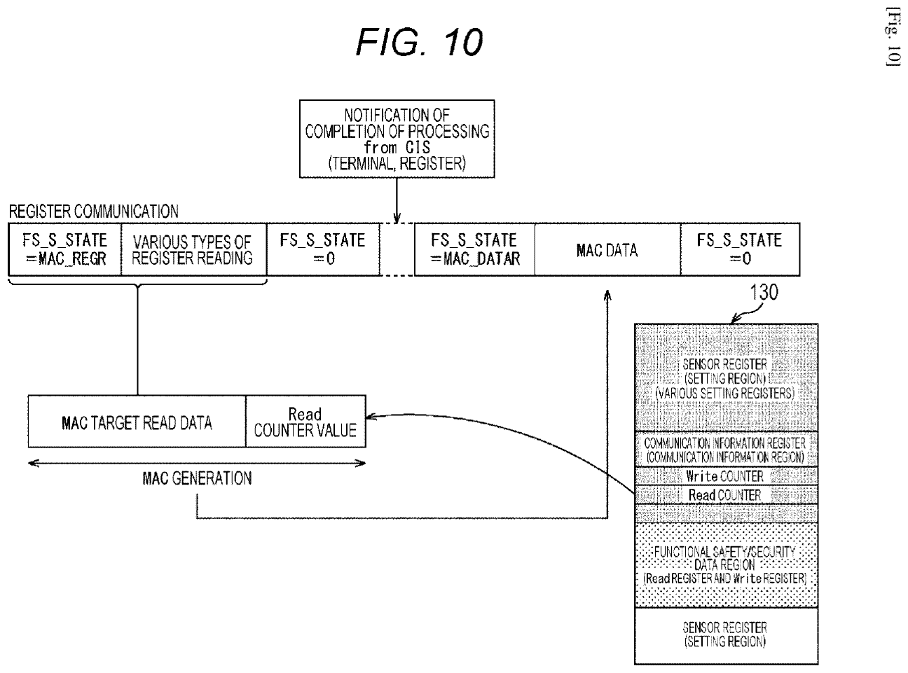

FIG. 10 illustrates an example of register communication in a case where a request for reading the setting information stored in the sensor register 311 is made from the host 2 in the MAC mode. In a case where there is a request for reading the setting information from the host 2, the CIS 1 reads the setting information stored in the sensor register 311 in response to the request, and outputs the setting information to the host 2 via the register F.

First, a status FS_S_STATE=MAC_REGR indicating a request to start reading the setting information in the MAC mode is transmitted as the communication information from the host 2 via the register IF. The CIS 1 performs one-time write of an operation mode value (MAC_REGR) to the FS_S_STATE register of the communication information register 312. In the CIS 1, the setting information stored in the sensor register 311 is read, and the read data is output to the host 2 via the register IF. The setting information includes, for example, a register address and a setting value of the sensor register 311 to be read.

Next, a status FS_S_STATE=0 indicating a request to end reading the setting information in the MAC mode is transmitted as the communication information from the host 2 via the register IF. In the CIS 1, the operation mode value of the FS_S_STATE register of the communication information register 312 is set to 0. Next, in the CIS 1, for example, a completion notification indicating that the read processing is completed is performed by the processing state FS_S_ACT. The notification may be made using the processing state output terminal 501 or the register IF.

Next, a status FS_S_STATE=MAC_DATAR indicating a request to start transmitting the security data in the MAC mode is transmitted as the communication information from the host 2 via the register IF. The CIS 1 performs one-time write of an operation mode value (MAC_DATAR) to the FS_S_STATE register of the communication information register 312.

Next, the CIS 1 generates the MAC data and writes the MAC data in the functional safety/security data region 313. The MAC data transmitted in the MAC mode is data generated by using MAC target read data and the read counter value as the MAC computation targets. The MAC target write data is a status FS_S_STATE=MAC_DATAR indicating a request to start transmitting the security data in the MAC mode and the setting information read from the sensor register 311 output from the CIS 1 to the host 2 via the register IF. The read counter value is a read counter value written to the register 130 of the CIS 1.

The MAC data is generated by the host 2 performing computation by using the data read from the CIS 1 and the read counter value as the MAC computation targets and using the common encryption secret key K (KB) (FIG. 4). Then, as described above, the generated MAC data is transmitted after the transmission of the status FS_S_STATE=MAC_DATAR indicating the start of reading in the MAC mode.

Next, a status FS_S_STATE=0 indicating a request to end reading of the security data in the MAC mode is transmitted as the communication information from the host 2 via the register IF. In the CIS 1, the operation mode value of the FS_S_STATE register of the communication information register 312 is set to 0.

As described above, by performing computation including the value of the read counter at the time of generating the MAC data, resistance to an attack such as spoofing can be imparted. It is also possible to enhance security for transmission of data from the CIS 1 to the host 2.

### Example of Operation of Read Counter

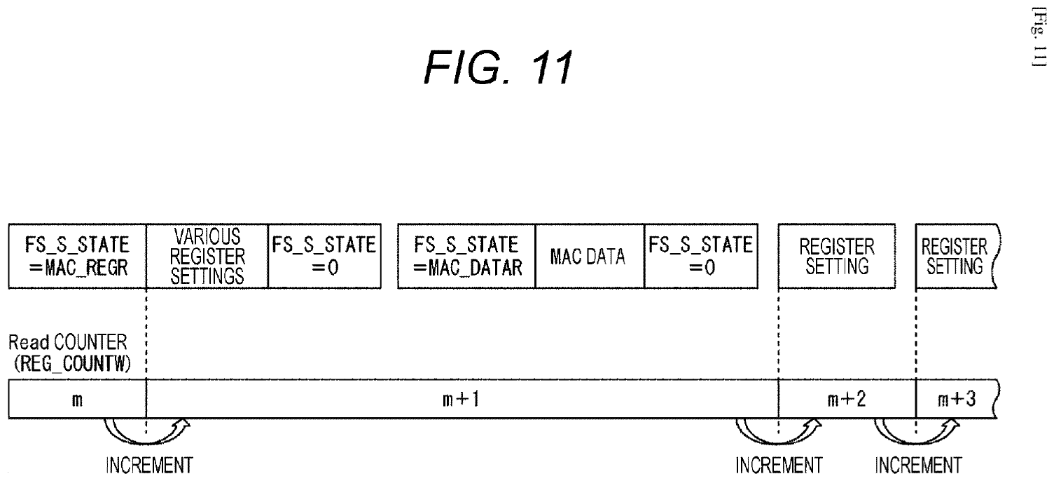

FIG. 11 is a sequence diagram illustrating an example of register communication including an operation of the read counter. FIG. 11 illustrates an example of register communication in a case where data is read from the register 130 in the MAC mode.

On the CIS 1 side, at a time point at which the register communication (FS_S_STATE=MAC_REGR) indicating a request for reading is generated, the read counter held in the register 130 is updated. The read counters held in the register 130 of the CIS 1 and the register 230 of the host 2 are synchronized with each other, and basically hold the same counter value. In the example illustrated in FIG. 11, the read counter of the register 130 is updated from m to m+1. In this case, the read counter value used to generate the MAC data is m+1.

In the host 2 side, the read counter value of the read counter held in the register 230 is incremented at a time point at which, register communication (FS_S_STATE=MAC_REGR) indicating the request for reading is received (processed). In the example illustrated in FIG. 11, the read counter value of the register 230 is updated from m to m+1.

In a case where the status FS_S_STATE=MAC_DATAR indicating the start of reading of data in the MAC mode is received, the host 2 holds the MAC data received thereafter in the register 230. The host 2 sets, as the MAC computation targets, various register setting values (data set as the MAC target read data on the CIS 1 side) received and written to the register 230 at a time point before receiving the MAC data and the read counter value held in the register 230, and generates the MAC data by using the common encryption secret key K held by the host 2.

The generated MAC data and the received MAC data are compared, and if they are the same, the data (various register setting values and the like) written to the register 230 is applied as safe data that has not been altered and if they are not the same, the data is determined as unsafe data and processed as an error.

In this manner, the MAC data is generated from data including the read counter value, and each read counter value is incremented according to communication in such a way that the values are the same between the CIS 1 and the host 2. Therefore, for example, even in a case where there is an attack such as spoofing, the processing can be continued without being affected by the attack. Since this is similar to the case of the write counter described above, a description thereof will be omitted here.

As described above, according to the present technology, security can be improved without affecting the communication band.

### <Processing in Data Transmission System at the Time of Reading>

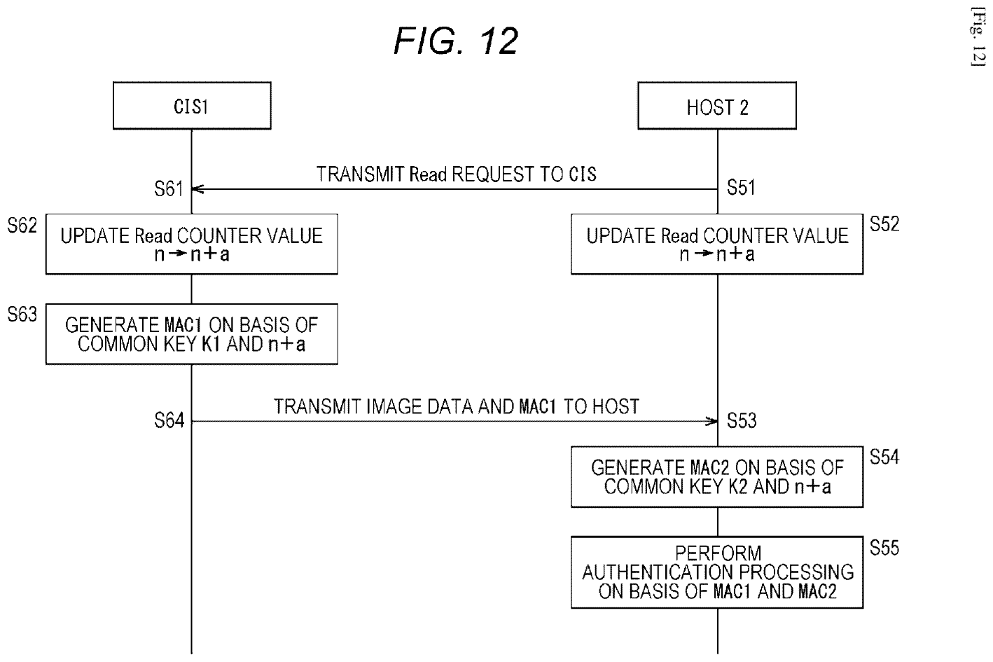

The processing in the data transmission system (FIG. 1) at the time of reading will be further described with reference to the timing chart of FIG. 12.

In step S51, the host 2 generates and transmits a read request to the CIS 1 as described with reference to FIG. 10.

In step S61, upon receiving the read request from the host 2, the CIS 1 proceeds to step S62. In step S62, the read counter value of the read counter held in the register 130 is updated. In a case where the read counter value held in the register 130 is n, the CIS 1 updates the read counter value to n+a.

In step S52, in the host 2 side, the read counter value of the read counter held in the register 230 is updated. In a case where the read counter value held in the register 230 is n, the host 2 updates the read counter value to n+a.

In the CIS 1 side, the read counter value is updated at a timing at which the read request is received, and in the host 2 side, the read counter value is updated at a timing at which the read request is transmitted.

In step S63, the CIS 1 generates the MAC 1 by using the updated read counter value, in this case, n+a. The MAC 1 is generated by performing computation using the read setting information (or image data) and the read counter value (in this case, n+a) as the MAC computation targets by using the common encryption secret key K1.

In step S64, the CIS 1 transmits the generated MAC 1 and the read image data (or various register setting values) to the host 2.

In step S53, upon receiving the MAC 1 and the image data from the CIS 1, the host 2 proceeds to step S54. In step S54, the host 2 performs computation using the received image data and the read counter value (in this case, n+a) held in the register 230 as the MAC computation targets, and generates the MAC 2 by using the common encryption secret key K2 held by the host 2.

In step S55, the host 2 performs authentication processing by comparing the received MAC 1 with the generated MAC 2. As a result of the authentication processing, if the MAC 1 and the MAC 2 are the same, the data is processed as safe data that has not been altered, and if the MAC 1 and the MAC 2 are not the same, the data is determined as unsafe data and processed as an error.

In a case where the data is processed as an error, an error notification is made from the host 2 to the CIS 1, and processing for resolving the error, for example, processing related to synchronization of the read counter value is performed.

In a case where there is data to be read from the CIS 1, the processing described with reference to FIG. 12 is performed in each of the CIS 1 and the host 2, so that the processing of reading data from the CIS 1 including the authentication process is performed. In a case where a plurality of data is transmitted from the CIS 1 to the host 2, the processing from step S51 to step S55 and the processing from step S61 to step S64 are repeatedly performed.

### <Another Processing in Data Transmission System at the Time of Reading>

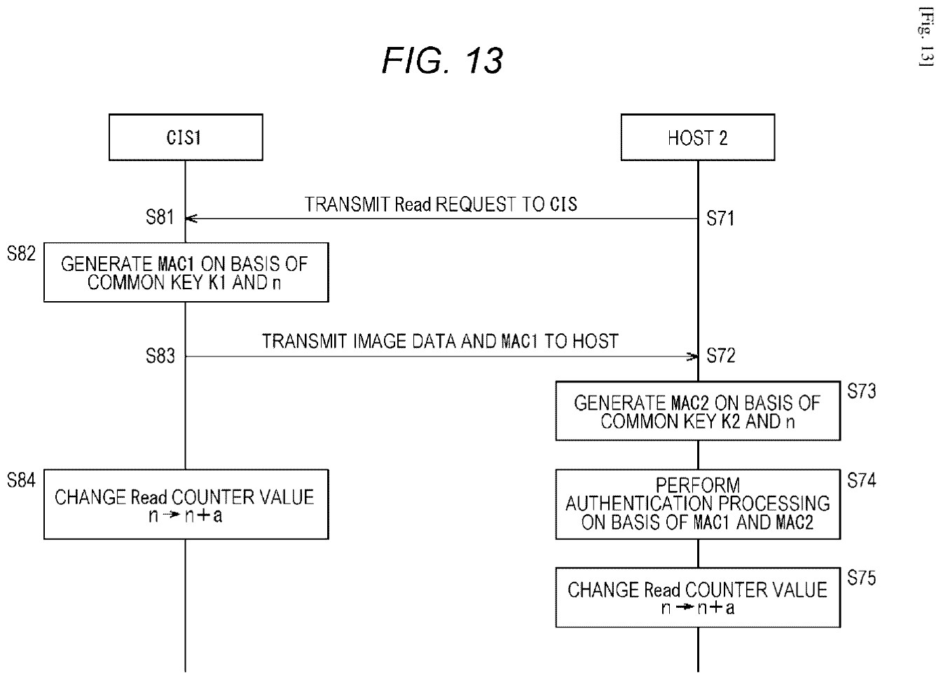

Another processing in the data transmission system (FIG. 1) at the time of reading will be further described with reference to the timing chart of FIG. 13.

In step S71, the host 2 generates and transmits a read request to the CIS 1 as described with reference to FIG. 10.

In step S81, upon receiving the read request from the host 2, the CIS 1 proceeds to step S82. In step S82, the CIS 1 generates the MAC 1 by using the read counter value (here, n) held in the register 130. The MAC 1 is generated by performing computation using the setting information (image data) read by the CIS 1 and the read counter value (In this case, n) as the MAC computation targets by using the common encryption secret key K1.

In step S83, the CIS 1 transmits the generated MAC 1 and the read image data (or various register setting values) to the host 2.

In step S72, upon receiving the MAC 1 and the image data from the CIS 1, the host 2 proceeds to step S73. In step S73, the host 2 performs computation using the received image data and the read counter value (in this case, n) held in the register 230 as the MAC computation targets, and generates the MAC 2 by using the common encryption secret key K2 held by the host 2.

In step S74, the host 2 performs authentication processing by comparing the received MAC 1 with the generated MAC 2. As a result of the authentication processing, if the MAC 1 and the MAC 2 are the same, the data is processed as safe data that has not been altered, and if the MAC 1 and the MAC 2 are not the same, the data is determined as unsafe data and processed as an error.

In step S75 after performing the authentication processing, the host 2 updates the read counter value of the read counter held in the register 230. In a case where the read counter value held in the register 230 is n, the read counter value is updated to n+a.

Although an example in which the host 2 transmits the read request and then updates the read counter value has been described in the read processing described with reference to FIG. 12, the host 2 updates the read counter value after performing the authentication processing in the read processing described with reference to FIG. 13. As described above, in the host 2, the read counter value can be updated after the authentication processing, and the updated counter value can be used at the time of generation of the next MAC.

In the CIS 1, the read counter value is updated in step S4. In a case where the read counter value of the read counter held in the register 130 is n, the CIS 1 updates the read counter value to n+a.

Although an example in which the CIS 1 updates the read counter value after the read request is received and before the MAC is generated has been described in the processing at the time of reading described with reference to FIG. 12, the CIS 1 updates the read counter value after the MAC data is generated in the processing at the time of reading described with reference to FIG. 13.

In a case where there is data to be read in the CIS 1, the processing described with reference to FIG. 13 is performed in each of the CIS 1 and the host 2, so that the processing of writing data to the CIS 1 including the authentication processing is performed.

### <Processing at the Time of Occurrence of Out-of-Synchronization of Counter>

The write counter and the read counter managed by the CIS 1 and the host 2 are basically synchronized with each other, but it is conceivable that out-of-synchronization occurs for some reason, for example, an attack by an attacker as described above. Processing in a case where the out-of-synchronization of the counters has occurred will be described with reference to the timing chart of FIG. 14.

A communication period during which synchronization can be normally performed is referred to as a normal communication period T1. In the normal communication period T1, the write counters and the read counters of the CIS 1 and the host 2 are n and m, respectively, and are in a synchronized state. In the normal communication period T1, the MAC data based on the data including the write counter value, in this case, n, is generated and transmitted from the host 2 to the CIS 1 as described with reference to FIGS. 6 and 7, and verification using the MAC data is performed in the CIS 1 side, whereby whether or not the data has been altered is verified.

In a case where it is confirmed that there is no error in the CIS 1 side in the normal communication period T1, communication for making a notification that it is confirmed that there is no error may be performed from the CIS 1 to the host 2. In this communication, as described with reference to FIGS. 10 and 11, the MAC data based on data including the read counter value, in this case, m, is generated and transmitted, and verification using the MAC data is performed in the host 2 side, whereby verification as to whether or not the data has been altered or the like is performed.

In a case where communication is performed normally, in other words, communication is performed without detecting an error in the normal communication period T1, each of the write counter and the read counter are updated in a case where writing or reading is performed, and communication is continued in a state where the CIS 1 and the host 2 are synchronized with each other.

A period in which the out-of-synchronization of the counters has occurred for some reason is referred to as an out-of-synchronization period T2. In the out-of-synchronization period T2, it is assumed that the write counter of the CIS 1 is n+x (x is a difference caused by the out-of-synchronization) and the read counter is in +1. It is assumed that the write counter in the host 2 side is n+1 and the read counter is m+1. In this case, the write counters are out of synchronization, and despite n+1 is a correct counter value, a counter value of n+x other than n+1 is set in the CIS 1.

In the out-of-synchronization period T2, the MAC data based on data including the write counter value, in this case, n+1, is generated and transmitted from the host 2 to the CIS 1. The CIS 1 performs verification using the MAC data, but it is determined that the MAC data does not match and an error has occurred because the write counters are out of synchronization.

In the out-of-synchronization period T2, since it is detected that an error has occurred in the CIS 1 side, communication for making a notification that an error has been detected is performed from the CIS 1 to the host 2.

Here, a case where an error has been detected in the CIS 1 side and communication for making a notification that an error has been detected is performed from the CIS 1 to the host 2 is described as an example. However, there is also a case where an error is detected in the host 2 side, and in a case where an error has been detected in the host 2 side, communication for making a notification that an error has been detected is performed from the host 2 to the CIS 1.

In a case where an error has been detected and a notification indicating that the error has been detected is made, the processing shifts to a synchronization restoration period T3 for restoring the synchronization state. In the synchronization restoration period T3, the write counter value is transmitted from the side where the error is detected, in this case, the CIS 1 side to the host 2 side. In the example illustrated in FIG. 14, the write counter of the CIS 1 in the synchronization restoration period T3 is n+x+1, and the read counter is in +2.

In the example illustrated in FIG. 14, n+x+1 is supplied as the write counter from the CIS 1 to the host 2 in response to the request for reading from the host 2. In a case where the write counter value is from the CIS 1 is read, the host 2 updates the write counter of the register 230 managed by the host 2 to the read counter value. In the example illustrated in FIG. 14, n+1 is updated to n+x+1. By performing such an update, the write counter managed by the CIS 1 and the write counter managed by the host 2 are n+x+1 and are in a synchronized state.

In a case where the counter values before and after the update greatly deviate from each other, in the example illustrated in FIG. 14, in a case where the value of x is large, occurrence of an attack can be detected.

Although not illustrated, in a case of the read processing, authentication processing is performed in the host 2 side, and an error may be detected. In such a case, communication for notifying that an error has been detected is performed from the host 2 to the CIS 1. In addition, the read counter value is transmitted from the host 2 to the CIS 1, and the CIS 1 performs processing for returning to a synchronized state by updating the read counter value to the read counter value received from the host 2.

Once the synchronization of the counter values is restored, a normal communication period T4 is reached, and normal communication is resumed. In the normal communication period T4, similarly to the normal communication period T1, the MAC data based on data including the write counter value, in this case, n+x+1, is generated and transmitted from the host 2 to the CIS 1, and verification using the MAC data is performed in the CIS 1 side. It is confirmed that there is no error in the CIS 1 side, and communication for making a notification that it is confirmed that there is no error is performed from the CIS 1 to the host 2.

As described above, even in a case where the counters are out-of-synchronization, it is possible to easily restore the synchronization. An attack can also be detected by a difference between the counters in a case where synchronization is restored.

### <Case of Managing Counter in Only One Side>

In the above-described embodiment, a case where the CIS 1 and the host 2 each include the register and each manage the write counter and the mad counter has been described as an example. Next, a case where the CIS 1 manages the write counter and the read counter in the register 130, but the host 2 does not manage the counter will be described.

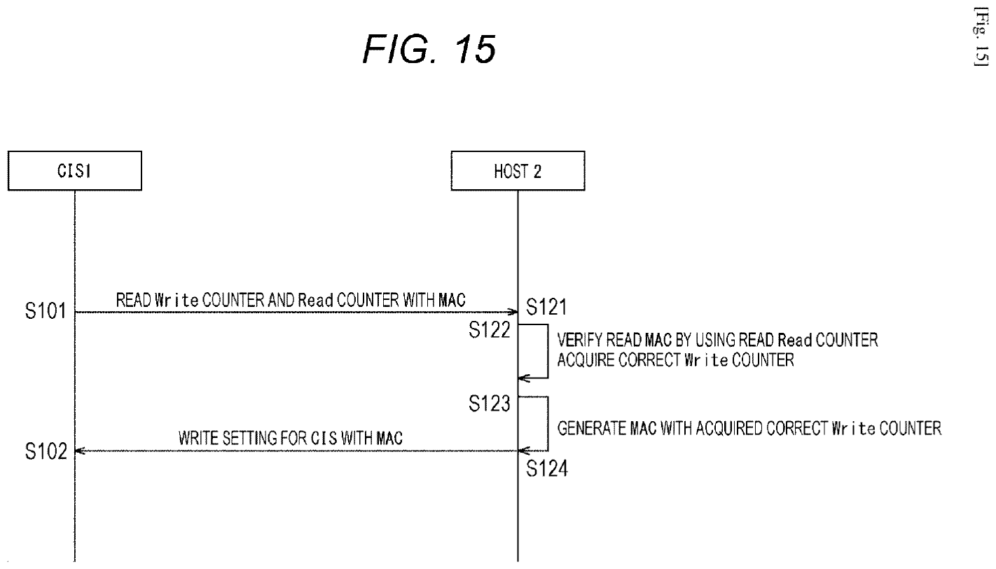

Processing related to writing in a case where the CIS 1 manages the counter and the host 2 does not manage the counter will be described with reference to the timing chart of FIG. 15.

In step S101, the write counter and the read counter managed by the CIS 1 are transmitted from the CIS 1 to the host 2 by reading with the MAC. The reading with the MAC is the reading described with reference to FIGS. 10 and 9. In this case, the write counter and the read counter are set as the read data, and the MAC data for which the data and the read counter value are set as the MAC computation targets is generated and transmitted. In step S121, the host 2 receives the write counter and the read counter from the CIS 1, and the MAC data.

In step S122, the host 2 generates the MAC data in which the read counter that has been read (is included in the received data) and the received data are set as the MAC computation targets, and verifies the MAC by comparing the generated MAC data with the received MAC data. In a case where the generated MAC data matches the received MAC data, it is determined that a correct write counter has been acquired, and the processing proceeds to step S123. Note that, in a case where the generated MAC data does not match the received MAC data, it is processed as an error.

In step S123, the host 2 generates the MAC data by using the acquired write counter value which has been verified to be correct. The write counter value corresponds to the write counter value managed by the register 230 of the host 2 in the example described with reference to FIG. 6, and the host 2 can generate the MAC data for which data including the write counter value is set as the target and transmit the MAC data to the CIS 1 as described with reference to FIG. 6.

In step S124, the write target data is transmitted from the host 2 to the CIS 1 together with the generated MAC data. These pieces of data are received by the CIS 1 in step S102. The CIS 1 can receive the MAC data for which data including the write counter value is set as the MAC computation target, and verify safety of the received data with the MAC data.

As described above, even in a case where the host 2 side does not manage the counter, the MAC data using the counter value can be generated to verify the safety of the data. As described above, according to the present technology, security can be improved without affecting the communication band.

<Processing in Case of Performing Transmission/Reception with Plurality of Hosts>

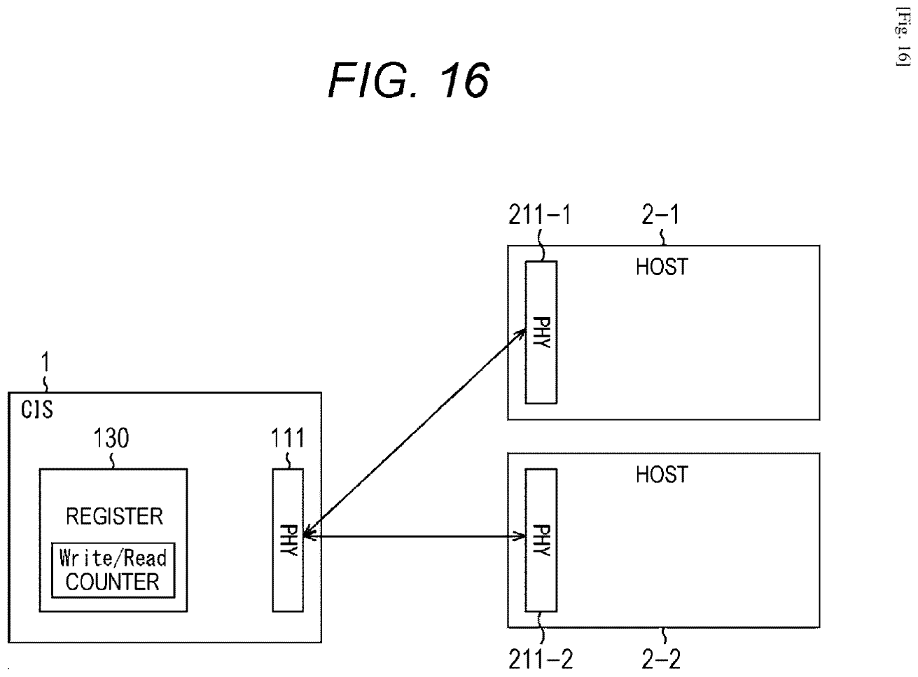

The present technology is not applied only to a one-to-one relationship between the CIS 1 and the host 2, and can also be applied to a case where the CIS 1 and the host 2 are in a one-to-many relationship or a case where the CIS 1 and the host 2 are in a many-to-one relationship. As illustrated in FIG. 16, a case where one CIS 1 and two hosts 2-1 and 2-2 transmit and receive data is taken as an example, and a case where the MAC data using the counter value is transmitted and received as described above will be described.

As illustrated in FIG. 16, the CIS 1 communicates with a host 2-1 via a PHY 1 and PHY 211-1. The CIS 1 also communicates with a host 2-2 via the PHY 11l and a PHY 211-2. In such a case, in the CIS 1, the write counter and the read counter are updated by communication with the host 2-1, and the write counter and the read counter are updated by communication with the host 2-2.

Here, a case where the counter values are synchronized by supplying the counter values from the CIS 1 to the host 2-1 and the host 2-2 as necessary will be described as an example. In addition, as illustrated in FIG. 16, a case where the CIS 1 includes the register 130 and manages the write counter and the read counter in the register 130, but the host 2-1 and the host 2-2 do not manage the write counter and the read counter will be described as an example.

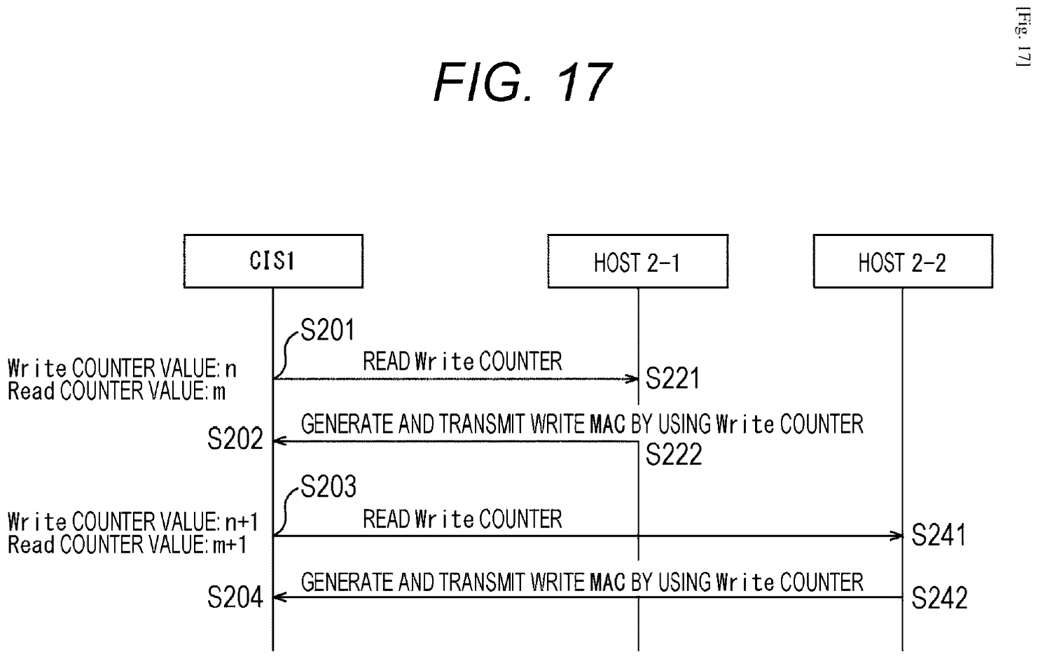

The processing in a case of the system as illustrated in FIG. 16 will be described with reference to the timing chart of FIG. 17. In a case where the write counter value of the CIS 1 is n and the read counter value is m, the write counter value is supplied from the CIS 1 to the host 2-1 in step S201. For example, the host 2-1 makes a request for reading the write counter, and in response to the request, the CIS 1 supplies the write counter value (in this case, n) managed by the CIS 1 itself to the host 2-1.

In step S221, the host 2-1 receives the write counter value from the CIS 1. In step S222, the host 2-1 generates the MAC data for which the received write counter value and the write data are set as the MAC computation targets, and transmits the MAC data after transmitting the write data as described with reference to FIG. 6.

In step S202, the CIS 1 receives the write data from the host 2-1 and performs processing of writing the write data in the register 130, processing of updating the write counter value, and the like.

In step S203, the write counter value is supplied from the CIS 1 to the host 2-2 by processing similar to that in step S201. The write counter value supplied at this time is n+1. In step S241, the host 2-2 receives the write counter value from the CIS 1. In step S242, the host 2-2 generates the MAC data for which the received write counter value and the write data are set as the MAC computation targets, and transmits the MAC data after transmitting the write data as described with reference to FIG. 6.

In step S204, the CIS 1 receives the write data from the host 2-2 and performs processing of writing the write data in the register 130, processing of updating the write counter value, and the like.

In this manner, as the CIS 1 manages the counter and supplies the counter to the host 2 side as necessary, it is possible to generate the MAC data based on the data including the counter value and perform verification using the MAC data.

<Another Processing in Case of Performing Transmission/Reception with Plurality of Hosts>

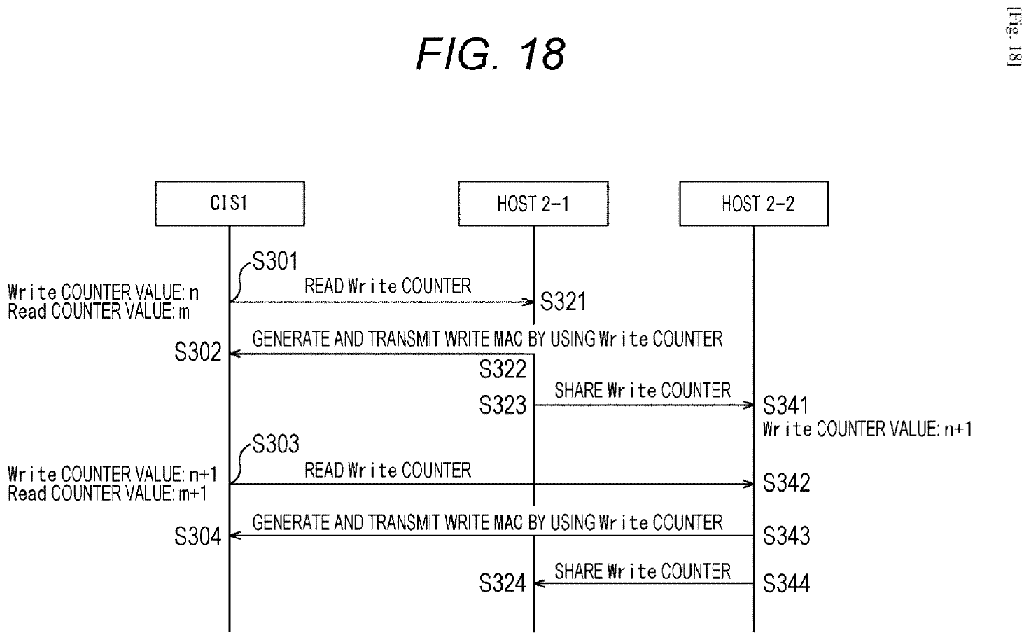

As illustrated in FIG. 16, another processing related to synchronization of the counters in the system including the CIS 1 and the two hosts 2-1 and 2-2 will be described with reference to the timing chart of FIG. 18.

In step S301, the write counter value is read by the CSI 1 and supplied to the host 2-1. In step S321, the host 2 receives the write counter value from the CSI 1, generates the MAC data using the received write counter, and transmits the MAC data together with the write target data to the CIS 1 (step S322).

In step S302, the CIS 1 receives the write target data and the MAC data from the host 2-1, and verifies the data using the MAC data. The communication between the CIS 1 and the host 2 so far is performed similarly to Steps S201, S202, S221, and S222 in FIG. 17.

In a case where the write counter is received and the MAC data using the write counter is generated, the host 2 supplies the updated write counter to another host 2. In this case, in step S323, the host 2-1 supplies the updated write counter to the host 2-2. In the example illustrated in FIG. 18, the host 2-1 updates the write counter value from n to n+1, and supplies the write counter value of n+1 to the host 2-2.

In step S341, the host 2-2 receives the write counter value from the host 2-1 and stores the write counter value in its own register. Both the host 2-1 and the host 2-2 are in a state of managing n+1 as the write counter value. In addition, the CIS 1 also updates the write counter value from n to n+1 at a time point at which the write data is received from the host 2-1 (step S302). Therefore, the CIS 1, the host 2-1, and the host 2-2 are in a state of managing n+1 as the write counter value, and the counters are in a synchronized state.

In step S303, the write counter value is supplied from the CIS 1 to the host 2-2. The CIS 1 supplies the write counter value (in this case, n+1) managed by the CIS 1 itself to the host 2-2.

In step S342, the host 2-2 receives the write counter value from the CIS 1. The host 2-2 determines whether or not the write counter value from the CIS 1 and the managed write counter value match, and performs the subsequent processing in a case where the write counter values match. On the other hand, in a case where it is determined that the write counter value from the CIS 1 and the managed write counter value do not match, the host 2-2 determines that any error due to an attack has occurred, and performs processing corresponding to the error. For example, processing of notifying the CIS 1 and the host 2-1 of the error is performed.

In the example illustrated in FIG. 18, since the received write counter value is n+1 and the managed write counter value is n+1, it is determined that the write counter values match, and the processing proceeds to step S343. In step S343, the host 2-2 generates the MAC data for which the received write counter value and the write data are set as the MAC computation targets, and transmits the MAC data after transmitting the write data as described with reference to FIG. 6.

In step S304, the CIS 1 receives the write data from the host 2-2 and performs processing of writing the write data in the register 130, processing of updating the write counter value, and the like.

After transmitting the write data (step S343), the host 2-2 performs processing related to sharing of the write counter with respect to the host 2-1. That is, the host 2-2 transmits the write counter value incremented by 1, in this case, n+2, to the host 2-1. In step S324, the host 2-1 receives the write counter value from the host 2-2, and updates the write counter value managed by the host 2-1 itself to the received write counter value.

In this manner, the processing related to the synchronization of the counter values is performed among the CIS 1, the host 2-1, and the host 2-2, and a state in which the synchronization of the counter values is kept is maintained.

<In Case of Communicating with Plurality of CISs>

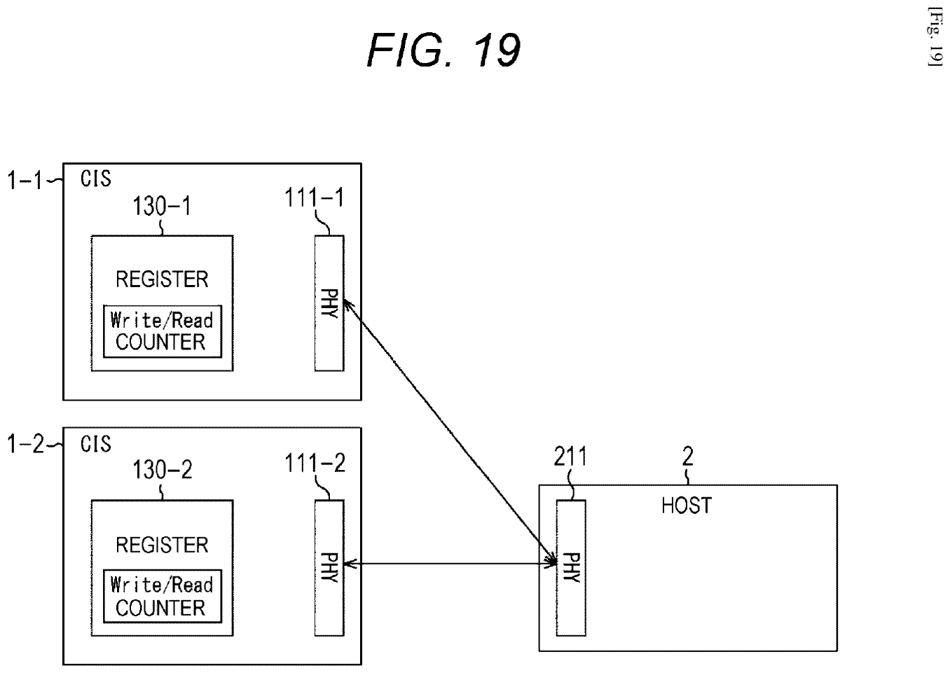

As illustrated in FIG. 19, a case where one host 2 and two CISs 1-1 and 1-2 transmit and receive data is taken as an example, and a case where the MAC data using the counter value is transmitted and received as described above will be described.

As illustrated in FIG. 19, the host 2 communicates with the CIS 1-1 via a PHY 211 and a PHY 111-1. The host 2 also communicates with the CIS 1-2 via a PHY 211 and a PHY 111-2. Here, a case where the counter values are synchronized between the CIS 1 and the host 2 by supplying the counter value from the CIS 1-1 to the host 2 as necessary and supplying the counter value from the CIS 1-2 to the host 2 as necessary will be described as an example.

As illustrated in FIG. 19, the CIS 1-1 includes a register 130-1, and manages the write counter and the read counter in the register 130-1. The CIS 1-2 also includes a register 130-2, and manages the write counter and the read counter in the register 130-2. The host 2 does not manage the write counter and the read counter.

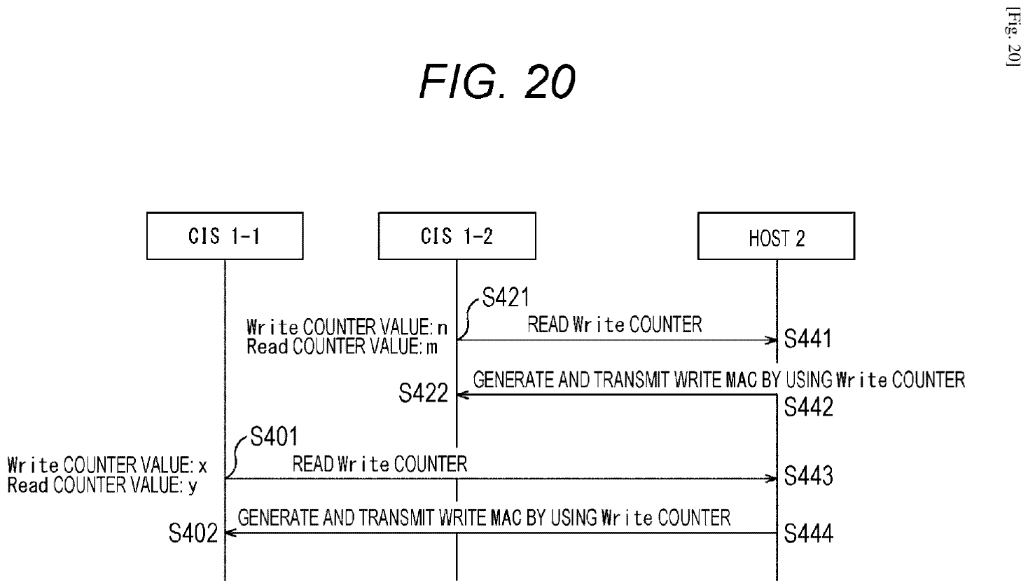

The processing in a case of the system as illustrated in FIG. 19 will be described with reference to the timing chart of FIG. 20. In a case where the write counter value of the CIS 1-2 is n and the read counter value is m, the write counter value is supplied from the CIS 1-2 to the host 2 in step S421. The CIS 1-2 supplies the write counter value (in this case, n) managed by the CIS 1-2 itself to the host 2.

In step S441, the host 2 receives the write counter value from the CIS 1-2. In step S442, the host 2 generates the MAC data for which the received write counter value and the write data are set as the MAC computation targets, and transmits the MAC data after transmitting the write data as described with reference to FIG. 6.

In step S422, the CIS 1-2 receives the write data from the host 2 and performs processing of writing the write data in the register 130-2, processing of updating the write counter value, and the like.

In a case where the write counter value of the CIS 1-1 is x and the read counter value is y, the write counter value is supplied from the CIS 1-1 to the host 2 in step S401. The CIS 1-1 supplies the write counter value (in this case, x) managed by the CIS 1-1 itself to the host 2.

In step S443, the host 2 receives the write counter value from the CIS 1-1. In step S444, the host 2 generates the MAC data for which the received write counter value and the write data are set as the MAC computation targets, and transmits the MAC data after transmitting the write data as described with reference to FIG. 6.

In step S402, the CIS 1-1 receives the write data from the host 2 and performs processing of writing the write data in the register 130-1, processing of updating the write counter value, and the like.

In this manner, as each of the CIS 1-1 and the CIS 1-2 manages the counter and supplies the counter to the host 2 side as necessary, it is possible to generate the MAC data based on the data including the counter value and perform verification using the MAC data.

According to the present technology, corresponding communication can be implemented also for alteration or replay attack by including the counter value as the MAC calculation target. Since the counter value in the CIS 1 has a register value that can be read by the host 2, it is possible to confirm the value in a case where out-of-synchronization has occurred. By separating the write counter and the read counter, the write operation and the read operation can have independent functions.

### <Recording Medium>

The above-described series of processing can be performed by hardware or software. In a case where the series of pieces of processing is performed by software, a program constituting the software is installed in a computer. Here, the computer includes a computer incorporated in dedicated hardware, a general-purpose personal computer capable of executing various functions by installing various programs, and the like, for example.

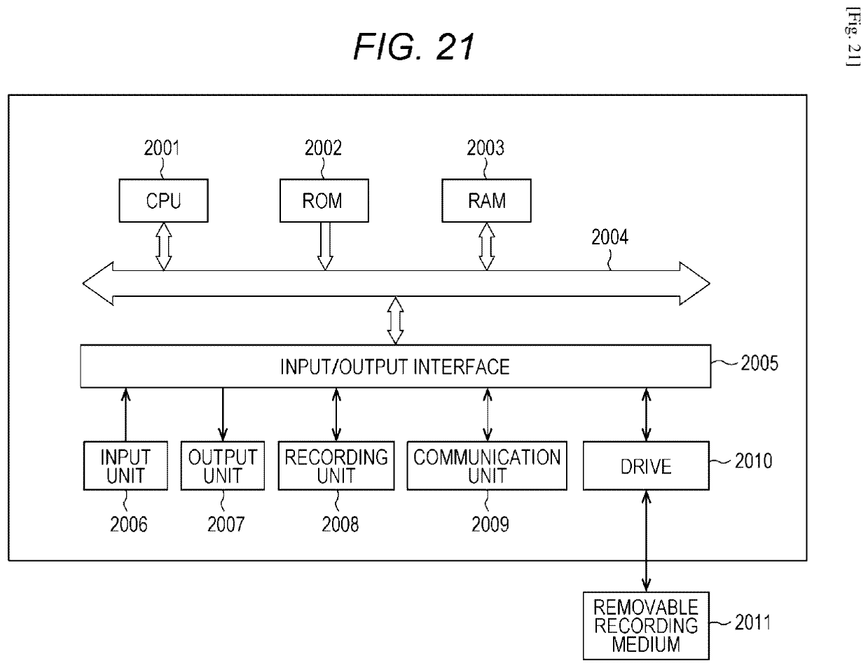

FIG. 21 is a block diagram illustrating an example of a configuration of hardware of a computer performing the series of pieces of processing described above by using a program. In the computer, a central processing unit (CPU) 2001, a read only memory (ROM) 2002, and a random access memory (RAM) 2003 are connected to one another by a bus 2004. Moreover, an input/output interface 2005 is connected to the bus 2004. An input unit 2006, an output unit 2007, a storage unit 2008, a communication unit 2009, and a drive 2010 are connected to the input/output interface 2005.

The input unit 2006 includes a keyboard, a mouse, a microphone, and the like. The output unit 2007 includes a display, a speaker, and the like. The storage unit 2008 includes a hard disk, a nonvolatile memory, and the like. The communication unit 2009 includes a network interface and the like. The drive 2010 drives a removable medium 2011 such as a magnetic disk, an optical disk, a magneto-optical disk, or a semiconductor memory.

In the computer configured as described above, the CPU 2001 loads, for example, a program stored in the storage unit 2008 to the RAM 2003 through the input/output interface 2005 and the bus 2004, and executes the program, such that the series of pieces of processing described above is performed.

The program executed by the computer (CPU 2001) can be provided by being recorded in the removable medium 2011 as a package medium or the like, for example. Furthermore, the program can be provided via a wired or wireless transmission medium such as a local region network, the Internet, or digital satellite broadcasting.

In the computer, the program can be installed in the storage unit 2008 via the input/output interface 2005 by mounting the removable medium 2011 on the drive 2010. Furthermore, the program can be received by the communication unit 2009 via a wired or wireless transmission medium and installed in the storage unit 2008. In addition, the program can be installed in the ROM 2002 or the storage unit 2008 in advance.

### Example of Application to Mobile Body

The technology of the present disclosure (present technology) can be applied to various products. For example, the technology according to an embodiment of the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

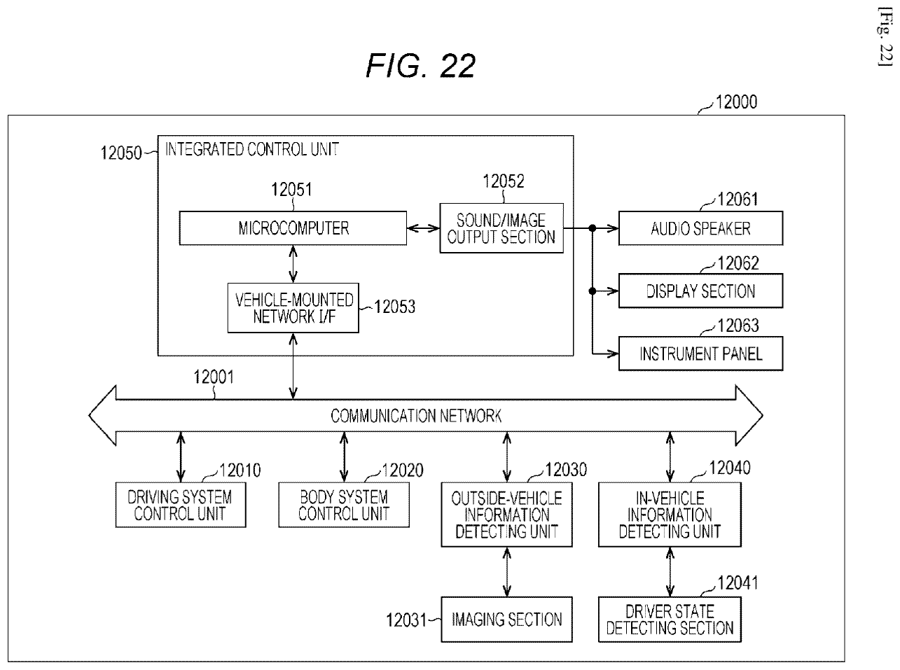

FIG. 22 is a block diagram illustrating an example of a schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example illustrated in FIG. 22, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 22, an audio speaker 12061, a display section 12062, and an instrument panel 12063 are illustrated as the output device. The display section 12062 may, for example, include at least one of an on-board display and a head-up display.

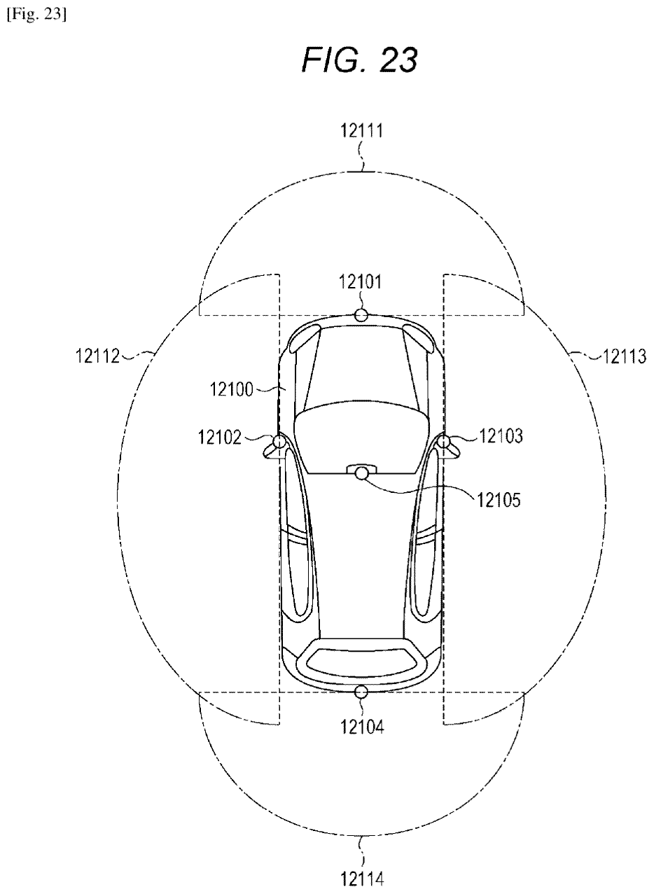

FIG. 23 is a view illustrating an example of the installation position of the imaging section 12031.

In FIG. 23, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 23 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by super-imposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (fir example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to the present disclosure can be applied has been described above. In the technology according to the present disclosure, the CIS 1 can be applied as the imaging section 12031, and the host 2 can be applied as the outside-vehicle information detecting unit 12030 in the above-described configuration. Alternatively, the CIS 1 can be applied as the driver state detecting section 12041, and the host 2 can be applied as the in-vehicle information detecting unit 12040. Therefore, the vehicle control system 12000 can perform authentication processing between the CIS 1 and the host 2, and can detect whether or not a malicious action such as replacement of the CIS 1 or the host 2 or alteration of data has been made. As a result, in the vehicle control system 12000, it is possible to implement a security function for preventing a traffic accident caused by a malicious action such as replacement of a camera or alteration of image data.

Note that the program executed by the computer may be a program by which the pieces of processing are performed in time series in the order described in the present specification, or may be a program by which the pieces of processing are performed in parallel or at a necessary timing such as when a call is performed or the like.

In the present specification, the system represents the entire apparatus including a plurality of apparatuses.

Note that the effects described in the present specification are merely illustrative and not limitative, and the present technology may have other effects.

Note that the embodiment of the present technology is not limited to that described above, and may be variously changed without departing from the gist of the present technology.

Note that the present technology can also have the following configuration.

(1)

A data processing apparatus including:
a generation unit that generates, in a case of transmitting data to another data processing apparatus, a message authentication code for which a counter value obtained by counting a request for the transmission and the data are set as computation targets; and
a transmission unit that transmits the message authentication code generated by the generation unit after the transmission of the data.
   (2)

The data processing apparatus according to (1), further including
a register having a region for storing the counter value.
   (3)

The data processing apparatus according to (1) or (2), in which
the counter value is supplied from the another data processing apparatus.
   (4)

The data processing apparatus according to any one of (1) to (3), in which
in a case where the message authentication code is received, a message authentication code for which the received data and the counter value managed by the data processing apparatus are set as computation targets is generated, and the generated message authentication code is compared with the received message authentication code to confirm safety of the data.
   (5)

The data processing apparatus according to (4), in which
in a case where the safety of the data is not confirmed, the counter value managed by the own register is transmitted to the another data processing apparatus.
   (6)

The data processing apparatus according to any one of (1) to (5), in which
the data processing apparatus is an image sensor or a host that controls the image sensor.
   (7)

The data processing apparatus according to (6), in which
in a case where the image sensor exchanges data with a plurality of the hosts, the image sensor reads and supplies the counter value managed by the image sensor in response to a request from the host.
(8)

The data processing apparatus according to (6) or (7), in which
the host compares the counter value supplied from another host with the counter value supplied from the image sensor, generates the message authentication code in a case where the counter values match, and transmits the message authentication code to the image sensor.
   (9)

The data processing apparatus according to (6), in which
the another data processing apparatus is the image sensor, and the image sensor has, in the register, a region for managing each of a write counter value obtained by counting a request for writing data to the register from the host and a read counter value obtained by counting a request for reading data managed in the register from the host.
   (10)

The data processing apparatus according to (9), in which
in a case where there is a request for reading from the host, the image sensor generates the message authentication code for which the read counter value managed by the image sensor and data for which the request for reading has been made are set as computation targets, and transmits the message authentication code to the host.
   (11)

The data processing apparatus according to any one of (1) to (10), in which
the message authentication code is generated using the counter value updated in a case where the request for the transmission is made.
   (12)
   The data processing apparatus according to any one of (1) to (10), in which
the counter value is updated after the message authentication code is generated and transmitted.
   (13)

A data processing method including:
by a data processing apparatus,
generating, in a case of transmitting data to another data processing apparatus, a message authentication code for which a counter value obtained by counting a request for the transmission and the data are set as computation targets; and
transmitting the generated message authentication code after the transmission of the data.
   (14)

A program for causing a computer that controls a data processing apparatus to execute processing of:
generating. in a case of transmitting data to another data processing apparatus, a message authentication code for which a counter value obtained by counting a request for the transmission and the data are set as computation targets; and
transmitting the generated message authentication code after the transmission of the data.

### (A1)

An image sensor comprising:
a first register storing a first key;
a second register storing a counter value;
a communication interface configured to communicate with a host device; and
a controller configured to
control the communication interface to receive a request from the host device,
change the counter value to generate an updated counter value, and
generate a message authentication code based on the first key and the updated counter value in response to receiving the request from the host device.

### (A2)

The image sensor according to (A1), wherein the request is a read request regarding setting information of the image sensor from the host device, wherein the controller is further configured to transmit the message authentication code and image data to the host device, and wherein the message authentication code is one part of an overall authentication with respect to the image data.

### (A3)

The image sensor according to (A2), wherein the controller is further configured to change the counter value to generate the updated counter value in response to receiving the read request.

### (A4)

The image sensor according to (A2) or (A3), wherein the counter value is a read counter value.

### (A5)

The image sensor according to any one of (A1) to (A4), wherein the request is a write request from the host device, and wherein the message authentication code is one part of an overall authentication with respect to the write request sent from the host device.

### (A6)

The image sensor according to (A5), wherein the counter value is a write counter value.

### (A7)

The image sensor according to (A5) or (A6), wherein the controller is further configured to
receive a second message authentication code from the host device, and
perform the overall authentication of the write request sent from the host device based on the message authentication code and the second message authentication code.

### (A8)

The image sensor according to (A7), wherein the controller is further configured to change the updated counter value to generate a second updated counter value after performing the overall authentication of the write request sent from the host device.

### (A9)

The image sensor according to (A7) or (A8), wherein the controller is further configured to send an error notification to the host device when a failure occurs in performing the overall authentication of the write request.

### (A10)

The image sensor according to (A9), wherein the controller is further configured to send the updated counter value to the host device in response to sending the error notification to the host device.

### (A11)

A host device comprising:
a first register storing a first key;
a second register storing a counter value;
a communication interface configured to communicate with an image sensor, and
a controller configured to
control the communication interface to transmit a request to the image sensor,
change the counter value to generate an updated counter value, and
generate a message authentication code based on the first key and the updated counter value in response to transmitting the request to the image sensor.

### (A12)

The host device according to (A11), wherein the request is a read request regarding setting information of the image sensor, and wherein the message authentication code is one part of an overall authentication with respect to image data that is received from the image sensor.

### (A13)

The host device according to (A12), wherein the controller is further configured to receive the image data and a second message authentication code from the image sensor, and
perform the overall authentication of the image data based on the message authentication code and the second message authentication code.

### (A14)

The host device according to (A12) or (A 13), wherein the counter value is a read counter value.

### (A15)

The host device according to (A14), wherein the controller is further configured to change the counter value to generate a second updated counter value in response to transmitting the read request, and
generate a third message authentication code based on the first key and the second updated counter value in response to generating the second updated counter value.

### (A16)

The host device according to any one of (A11) to (A15), wherein the request is a write request to the image sensor, wherein the controller is further configured to transmit the message authentication code to the image sensor, and wherein the message authentication code is one part of an overall authentication with respect to the write request.

### (A17)

The host device according to (A16), wherein the controller is further configured to change the counter value to generate a second updated counter value in response to transmitting the write request, and
generate a fourth message authentication code based on the first key and the second updated counter value in response to generating the second updated counter value.

### (A18)

The host device according to (A16) or (A17), wherein the counter value is a write counter value.

### (A19)

The host device according to any one of (A11) to (A18), wherein the controller is further configured to send the updated counter value to a second host device.

### (A20)

A method comprising:
controlling, with a controller of an image sensor, a communication interface to receive a request from a host device;
changing, with the controller, a counter value to generate an updated counter value; and
generating, with the controller, a message authentication code based on a first key and the updated counter value in response to receiving the request from the host device.

It should be understood by those skilled in the art that various modifications, combinations, sub-combinations and alterations may occur depending on design re-quirements and other factors insofar as they are within the scope of the appended claims or the equivalents thereof.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The claims shall have open-ended construction unless otherwise indicated. For example, the claim phrasing “at least one of A or B” shall be construed as reading upon embodiments that include either A or B, as well as embodiments that include both A and B.

The description and drawings merely illustrate the principles of the disclosure. It will thus be appreciated that those of ordinary skill in the art will be able to devise various arrangements that, although not explicitly described or shown herein, embody the principles of the disclosure and are included within its scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), logic circuitry, and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

### REFERENCE SIGNS LIST

1 CIS
2 Host
3 Transmission path
4 Transmission path
110 Communication unit
111 Physical layer
112 Link layer
113 Higher layer
120 Communication unit
123 Data processing unit
124 Sensor unit
130 Resistor
131 CPU
210 Communication unit
211 Physical layer
212 Link layer
213 Higher layer
220 Communication unit
223 Data processing unit
230 Resistor
231 CPU
232 Hardware
311 Sensor register
312 Communication information register
313 Security data region
410 Write determination unit
411 Register communication detection unit
412 Data computation unit
413 Error detection unit
414 Write counter control unit
501 Processing state output terminal
502 Error output terminal

The invention claimed is:

1. An image sensor comprising:
a first register storing a first key;
a second register storing a counter value;
a communication interface configured to communicate with a host device; and
a controller configured to
control the communication interface to receive a request from the host device,
change the counter value to generate an updated counter value, and
generate a message authentication code based on the first key and the updated counter value in response to receiving the request from the host device.

2. The image sensor according to claim 1, wherein the request is a read request regarding setting information of the image sensor from the host device, wherein the controller is further configured to transmit the message authentication code and image data to the host device, and wherein the message authentication code is one part of an overall authentication with respect to the image data.

3. The image sensor according to claim 2, wherein the controller is further configured to change the counter value to generate the updated counter value in response to receiving the read request.

4. The image sensor according to claim 2, wherein the counter value is a read counter value.

5. The image sensor according to claim 1, wherein the request is a write request from the host device, and wherein the message authentication code is one part of an overall authentication with respect to the write request sent from the host device.

6. The image sensor according to claim 5, wherein the counter value is a write counter value.

7. The image sensor according to claim 5, wherein the controller is further configured to
receive a second message authentication code from the host device, and perform the overall authentication of the write request sent from the host device based on the message authentication code and the second message authentication code.

8. The image sensor according to claim 7, wherein the controller is further configured to change the updated counter value to generate a second updated counter value after performing the overall authentication of the write request sent from the host device.

9. The image sensor according to claim 7, wherein the controller is further configured to send an error notification to the host device when a failure occurs in performing the overall authentication of the write request.

10. The image sensor according to claim 9, wherein the controller is further configured to send the updated counter value to the host device in response to sending the error notification to the host device.

11. A host device comprising:
a first register storing a first key;
a second register storing a counter value;
a communication interface configured to communicate with an image sensor; and
a controller configured to control the communication interface to transmit a request to the image sensor,
change the counter value to generate an updated counter value, and
generate a message authentication code based on the first key and the updated counter value in response to transmitting the request to the image sensor.

12. The host device according to claim 11, wherein the request is a read request regarding setting information of the image sensor, and wherein the message authentication code is one part of an overall authentication with respect to image data that is received from the image sensor.

13. The host device according to claim 12, wherein the controller is further configured to
receive the image data and a second message authentication code from the image sensor, and
perform the overall authentication of the image data based on the message authentication code and the second message authentication code.

14. The host device according to claim 12, wherein the counter value is a read counter value.

15. The host device according to claim 14, wherein the controller is further configured to
change the counter value to generate a second updated counter value in response to transmitting the read request, and
generate a third message authentication code based on the first key and the second updated counter value in response to generating the second updated counter value.

16. The host device according to claim 11, wherein the request is a write request to the image sensor, wherein the controller is further configured to transmit the message authentication code to the image sensor, and
wherein the message authentication code is one part of an overall authentication with respect to the write request.

17. The host device according to claim 16, wherein the controller is further configured to
change the counter value to generate a second updated counter value in response to transmitting the write request, and
generate a fourth message authentication code based on the first key and the second updated counter value in response to generating the second updated counter value.

18. The host device according to claim 16, wherein the counter value is a write counter value.

19. The host device according to claim 11, wherein the controller is further configured to send the updated counter value to a second host device.

20. A method comprising:
controlling, with a controller of an image sensor, a communication interface to receive a request from a host device;
changing, with the controller, a counter value to generate an updated counter value; and
generating, with the controller, a message authentication code based on a first key and the updated counter value in response to receiving the request from the host device.
